(19) United States
(12) Patent Application Publication
(10) Pub. No.: US 2025/0200719 A1
(43) Pub. Date: Jun. 19, 2025

(54) METHOD AND SYSTEM FOR REDUCING CHARGING ARTIFACT IN INSPECTION IMAGE

(71) Applicant: ASML Netherlands B.V., Veldhoven (NL)

(72) Inventors: Jasper Frans Mathijs VAN RENS, Hegelsom (NL); Gijs SMIT, Amsterdam (NL); Antoine Gaston Marie KIERS, Veldhoven (NL); Vlado MENKOVSKI, Eindhoven (NL)

(73) Assignee: ASML Netherlands B.V., Veldhoven (NL)

(21) Appl. No.: 18/867,005

(22) PCT Filed: May 8, 2023
(86) PCT No.: PCT/EP2023/062121

§ 371 Date: Nov. 19, 2024

(30) Foreign Application Priority Data
Jun. 7, 2022 (EP) 22177678.4

(51) Int. Cl. G06T 5/60; G06T 7/00; G06V 10/774

(52) U.S. Cl. CPC G06T 5/60; G06T 7/0004; G06V 10/774; G06T 2207/20081; G06T 2207/30148

(57) ABSTRACT

Systems and methods for reducing charging artifacts in an inspection image include obtaining a set of inspection images, in which each of the set of inspection images includes a charging artifact; and training a machine learning model using the set of inspection images as input, in which the machine learning model outputs a set of decoupled features of the set of inspection images.

### CROSS-REFERENCE TO RELATED APPLICATIONS

This application claims priority of EP application 22177678.4 which was filed on 7 Jun. 2022 and which is incorporated herein in its entirety by reference.

### FIELD

The description herein relates to the field of image inspection apparatus, and more particularly to reducing charging artifacts in inspection images using physics-based machine learning models.

### BACKGROUND

An image inspection apparatus (e.g., a charged-particle beam apparatus or an optical beam apparatus) is able to produce a two-dimensional (2D) image of a wafer substrate by detecting particles (e.g., photons, secondary electrons, backscattered electrons, mirror electrons, or other kinds of electrons) from a surface of a wafer substrate upon impingement by a beam (e.g., a charged-particle beam or an optical beam) generated by a source associated with the inspection apparatus. Various image inspection apparatuses are used on semiconductor wafers in semiconductor industry for various purposes such as wafer processing (e.g., e-beam direct write lithography system), process monitoring (e.g., critical dimension scanning electron microscope (CD-SEM)), wafer inspection (e.g., e-beam inspection system), or defect analysis (e.g., defect review SEM, or say DR-SEM and Focused Ion Beam system, or say FIB).

To control quality of a manufactured structures on the wafer substrate, the 2D image of the wafer substrate may be analyzed to detect potential defects in the wafer substrate. As the physical sizes of IC components continue to shrink, accuracy, and yield in defect detection become more and more important. However, when inspecting electrically insulating materials, the qualities of the SEM images typically suffer from SEM-induced charging artifacts. In some cases, such charging artifacts may cause a charge-induced critical dimension (CD) error. There are several techniques that can be used to reduce charging artifacts in SEM imaging, such as, for example, coating a target sample surface with a conducting material, optimizing landing energy of an electron beam in a SEM, using faster scanning, such as using a lower dose per SEM frame and using more SEM frames, using opposing scan-directions in a SEM, among others. It is noted, however, that those techniques have different disadvantages. Specifically, it is noted that experimental techniques to avoid charging (e.g., “quadscan” that performs four-direction scans and averages the measurements) may be slow and cause low throughput. Numerical image processing techniques may lack physics-based explainability. Further improvements in the art are desired.

### SUMMARY

Embodiments of the present disclosure provide systems and methods of reducing charging artifacts in an inspection image. In some embodiments, a system may include an image inspection apparatus configured to scan a sample and generate an inspection image of an integrated circuit fabricated on the sample, and a controller including circuitry. The controller may be configured to obtain a set of inspection images, wherein each of the set of inspection images includes a charging artifact. The controller may be also configured to train a machine learning model using the set of inspection images as input, wherein the machine learning model outputs a set of decoupled features of the set of inspection images.

In some embodiments, a system may include an image inspection apparatus configured to scan a sample and generate an inspection image of an integrated circuit fabricated on the sample, and a controller including circuitry. The controller may be configured to generate a set of simulated inspection images, wherein each of the set of simulated inspection images includes no charging artifact. The controller may be also configured to generate a set of inspection images by applying a physics-based model to the set of simulated inspection images. The controller may be further configured to train a machine learning model using the set of inspection images as input, wherein the machine learning model outputs a set of decoupled features of the set of inspection images. The controller may be further configured to apply the trained machine learning model on the inspection image to generate an output inspection image, wherein the output inspection image includes fewer charging artifacts than the inspection image.

In some embodiments, a non-transitory computer-readable medium may store a set of instructions that is executable by at least one processor of an apparatus to cause the apparatus to perform a method. The method may include obtaining a set of inspection images, wherein each of the set of inspection images includes a charging artifact. The method may also include training a machine learning model using the set of inspection images as input, wherein the machine learning model outputs a set of decoupled features of the set of inspection images.

In some embodiments, a non-transitory computer-readable medium may store a set of instructions that is executable by at least one processor of an apparatus to cause the apparatus to perform a method. The method may include generating a set of simulated inspection images, wherein each of the set of simulated inspection images includes no charging artifact. The method may also include generating a set of inspection images by applying a physics-based model to the set of simulated inspection images. The method may further include training a machine learning model using the set of inspection images as input, wherein the machine learning model outputs a set of decoupled features of the set of inspection images. The method may further include applying the trained machine learning model on an inspection image to generate an output inspection image, wherein the output inspection image includes fewer charging artifacts than the inspection image.

In some embodiments, a computer-implemented method for reducing charging artifacts in an inspection image may include obtaining a set of inspection images, wherein each of the set of inspection images includes a charging artifact. The computer-implemented method may also include training a machine learning model using the set of inspection images as input, wherein the machine learning model outputs a set of decoupled features of the set of inspection images.

In some embodiments, a computer-implemented method for reducing charging artifacts in an inspection image may include generating a set of simulated inspection images, wherein each of the set of simulated inspection images includes no charging artifact. The method may also include generating a set of inspection images by applying a physics-based model to the set of simulated inspection images. The method may further include training a machine learning model using the set of inspection images as input, wherein the machine learning model outputs a set of decoupled features of the set of inspection images. The method may further include applying the trained machine learning model on an inspection image to generate an output inspection image, wherein the output inspection image includes fewer charging artifacts than the inspection image.

### BRIEF DESCRIPTION OF THE DRAWINGS

FIG. 1 is a schematic diagram illustrating an example charged-particle beam inspection (CPBI) system, consistent with some embodiments of the present disclosure.

FIG. 2 is a schematic diagram illustrating an example charged-particle beam tool, consistent with some embodiments of the present disclosure that may be a part of the example charged-particle beam inspection system of FIG. 1.

FIG. 3 is a schematic diagram illustrating an example process of a charging effect induced by a charged-particle beam tool, consistent with some embodiments of the present disclosure.

FIG. 4 is a schematic diagram illustrating an example process for reducing charging artifacts in an inspection image, consistent with some embodiments of the present disclosure.

FIG. 5 is a schematic diagram illustrating an example neural network, consistent with some embodiments of the present disclosure.

FIG. 6 is a schematic diagram illustrating an example autoencoder, consistent with some embodiments of the present disclosure.

FIG. 7 is a schematic diagram illustrating an example process for reducing charging artifacts in an inspection image using a trained autoencoder, consistent with some embodiments of the present disclosure.

FIG. 8 is a schematic diagram illustrating a first example process for training an autoencoder, consistent with some embodiments of the present disclosure.

FIG. 9 is a schematic diagram illustrating a second example process for training an autoencoder, consistent with some embodiments of the present disclosure.

FIG. 10 is a flowchart illustrating an example method for reducing charging artifacts in an inspection image, consistent with some embodiments of the present disclosure.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the subject matter recited in the appended claims. Without limiting the scope of the present disclosure, some embodiments may be described in the context of providing detection systems and detection methods in systems utilizing electron beams (“e-beams”). However, the disclosure is not so limited. Other types of charged-particle beams (e.g., including protons, ions, muons, or any other particle carrying electric charges) may be similarly applied. Furthermore, systems and methods for detection may be used in other imaging systems, such as optical imaging, photon detection, x-ray detection, ion detection, or any imaging system that may cause charging effects (that will be described in this disclosure).

Electronic devices are constructed of circuits formed on a piece of semiconductor material called a substrate. The semiconductor material may include, for example, silicon, gallium arsenide, indium phosphide, or silicon germanium, or the like. Many circuits may be formed together on the same piece of silicon and are called integrated circuits or ICs. The size of these circuits has decreased dramatically so that many more of them may be fit on the substrate. For example, an IC chip in a smartphone may be as small as a thumbnail and yet may include over 2 billion transistors, the size of each transistor being less than 1/1000th the size of a human hair.

Making these ICs with extremely small structures or components is a complex, time-consuming, and expensive process, often involving hundreds of individual steps. Errors in even one step have the potential to result in defects in the finished IC, rendering it useless. Thus, one goal of the manufacturing process is to avoid such defects to maximize the number of functional ICs made in the process; that is, to improve the overall yield of the process.

One component of improving yield is monitoring the chip-making process to ensure that it is producing a sufficient number of functional integrated circuits. One way to monitor the process is to inspect the chip circuit structures at various stages of their formation. Inspection may be carried out using a scanning charged-particle microscope (“SCPM”). For example, an SCPM may be a scanning electron microscope (SEM). A SCPM may be used to image these extremely small structures, in effect, taking a “picture” of the structures of the wafer. The image may be used to determine if the structure was formed properly in the proper location. If the structure is defective, then the process may be adjusted, so the defect is less likely to recur.

The working principle of a SCPM (e.g., a SEM) is similar to a camera. A camera takes a picture by receiving and recording intensity of light reflected or emitted from people or objects. An SCPM takes a “picture” by receiving and recording energies or quantities of charged particles (e.g., electrons) reflected or emitted from the structures of the wafer. Typically, the structures are made on a substrate (e.g., a silicon substrate) that is placed on a platform, referred to as a stage, for imaging. Before taking such a “picture,” a charged-particle beam may be projected onto the structures, and when the charged particles are reflected or emitted (“exiting”) from the structures (e.g., from the wafer surface, from the structures underneath the wafer surface, or both), a detector of the SCPM may receive and record the energies or quantities of those charged particles to generate an inspection image. To take such a “picture,” the charged-particle beam may scan through the wafer (e.g., in a line-by-line or zig-zag manner), and the detector may receive exiting charged particles coming from a region under charged particle-beam projection (referred to as a “beam spot”). The detector may receive and record exiting charged particles from each beam spot one at a time and join the information recorded for all the beam spots to generate the inspection image. Some SCPMs use a single charged-particle beam (referred to as a “single-beam SCPM,” such as a single-beam SEM) to take a single “picture” to generate the inspection image, while some SCPMs use multiple charged-particle beams (referred to as a “multi-beam SCPM,” such as a multi-beam SEM) to take multiple “sub-pictures” of the wafer in parallel and stitch them together to generate the inspection image. By using multiple charged-particle beams, the SEM may provide more charged-particle beams onto the structures for obtaining these multiple “sub-pictures,” resulting in more charged particles exiting from the structures. Accordingly, the detector may receive more exiting charged particles simultaneously and generate inspection images of the structures of the wafer with higher efficiency and faster speed.

Wafer defect detection is a critical step for semiconductor volume production and process development in research and development phase. A wafer may include one or more dies. A die, as used herein, refers to a portion or block of wafer on which an integrated circuit may be fabricated. Typically, integrated circuits of the same design may be fabricated in batches on a single wafer of semiconductor, and then the wafer may be cut (or referred to as “diced”) into pieces, each piece including one copy of the integrated circuits and being referred to as a die. Several conventional techniques exist for wafer defect detection, including die-to-die (“D2D”) inspection technique, die-to-database (“D2DB”) inspection technique, and simulation-based inspection technique. Image analysis may be performed on the inspection images to identify potential defects in the structures manufactured on the wafer.

In the D2D inspection technique, for each of the dies on the wafer, an inspection image of the die (referred to as a “die inspection image”) may be generated. For example, the die inspection image may be an actually measured SEM image. The die inspection images may be compared and analyzed against each other for defect detection. For example, each pixel of a first die inspection image of a first die may be compared with each corresponding pixel of a second die inspection image of a second die to determine a difference in their gray-level values. Potential defects may be identified based on the pixel-wise gray-level value differences. For example, if one or more of the differences exceed a predetermined threshold, the pixels in at least one of the first die inspection image or the second die inspection image corresponding to the one of more of the differences may represent a part of a potential defect. In some embodiments, the die inspection images under comparison (e.g., the first die inspection image or the second die inspection image) may be associated with neighboring dies (e.g., the first die and the second die are randomly selected from dies being separated by less than four dies). In some embodiments, the die inspection images under comparison (e.g., the first die inspection image or the second die inspection image) may be associated with shifted-period dies (e.g., the first die and the second die are selected from dies being separated by a fixed number of dies).

In the D2DB inspection technique, a die inspection image of a die on the wafer may be compared with a rendered image generated from a design layout file (e.g., a GDS layout file) of the same die. The design layout file may include non-visual description of the integrated circuit in the die, and the rendering of the design layout file may refer to visualization (e.g., a 2D image) of the non-visual description. For example, the die inspection image may be compared with the rendered image to determine a difference in one or more of their corresponding features, such as, for example, pixel-wise gray-level values, gray-level intensity inside a polygon, or a distance between corresponding patterns. Potential defects may be identified based on the differences. For example, if one or more of the differences exceed a predetermined threshold, the pixels in the die inspection image corresponding to the one of more of the differences may represent a part of a potential defect.

In the simulation-based inspection technique, a die inspection image may be compared with a simulation image (e.g., a simulated SEM image) corresponding to the inspection image. In some embodiments, the simulation image may be generated by a machine learning model (e.g., a generative adversarial network or “GAN”) for simulating graphical representations of inspection images measured by the image inspection apparatus. The simulation image may be used as a reference to be compared with the die inspection image. For example, each pixel of the die inspection image may be compared with each corresponding pixel of the simulation image to determine a difference in their gray-level values. Potential defects may be identified based on the pixel-wise gray-level value differences. For example, if one or more of the differences exceed a predetermined threshold, the pixels in the die inspection image corresponding to the one of more of the differences may represent a part of a potential defect.

A phenomenon in image formation (for defect detection) is artifacts introduced by the inspection tools (e.g., a scanning charged-particle microscope). Such artifacts do not originate from actual defects of the final products. The artifacts may distort or deteriorate the quality of the image to be inspected, and cause difficulties or inaccuracies in defect detection. The distortions may be caused by charges that accumulate and change in dielectric materials of the wafer (e.g., a photoresist) when incident charged particles of a charged-particle inspection apparatus (e.g., a SEM) interact with the dielectric materials during the inspection. The accumulated charges may affect trajectories of charged particles entering and exiting the beam spot and causes metrology artifacts in the inspection images. Such metrology artifacts caused by the accumulated charges are referred to as “charging artifacts” in this disclosure. The charging artifacts may include, for example, grid distortions of a field of view (“FOV”), shadows due to local charging, contour deformations, placement errors, or the like. The charging artifacts may further cause inaccuracies in measurements of critical dimensions or edge placement based on the inspection images, or impede calibration of optical particle counters.

Several existing techniques may be used to reduce the charging artifacts described above. However, each of them has one or more technical challenges. For example, on a scale of a large FOV, one or more polynomial models may be used to correct low-frequency FOV grid distortions. However, the polynomial models may be unable to correct dark shadows or subtle contour deformations that occur on a nanometer scale. As another example, a quadscan technique may be used to mitigate charging artifacts, in which scans may be performed on the same sample from four different directions to generate an average inspection image. However, the quadscan technique can only average the charging artifacts but cannot eliminate them. Also, the order of the four scan directions may affect measured critical dimensions in the quadscan technique. Further, the quadscan technique may consume significant time because of the four scans for a single sample.

Embodiments of the present disclosure may provide methods, apparatuses, and systems for reducing charging artifacts in inspection images using a physics-based machine learning model (e.g., an autoencoder). In some disclosed embodiments, one or more simulated inspection images (e.g., simulated SEM images) may be generated using a simulation technique (e.g., a Monte-Carlo based SEM simulator) with various parameters (e.g., patterns, critical dimensions, pitches, depths of trenches, roughness of edges, or the like). Charging artifacts induced by a charged-particle inspection apparatus may be simulated in the simulated inspection images using a physics-based charging model. The physics-based charging model may perform the simulation using various charging parameters (e.g., scan directions, doses of charged particles, diffusion time of charges, or the like). Given that actual inspection images produced in actual measurements (i.e., not in simulations) have non-zero doses of charged particles, the physics-based charging model may also use non-zero doses of charged particles to simulate the charging artifacts in the simulated inspection images. After introducing the charging artifacts into the simulated inspection images, they can form a training set to train the machine learning model (e.g., the autoencoder). The trained machine learning model may be applied on actual inspection images to remove charging artifacts.

Compared with existing techniques for charging artifact reduction, the disclosed technical solutions herein provide various technical benefits. For example, the training set generated using the physics-based model may significantly reduce overcorrection introduced by machine learning models. Because non-zero doses of charged particles are used as parameters in the physics-based model, the training set may become more resembling to actual inspection images and thus reduce inference errors of the machine learning model. The simulation technique may generate simulated inspection images with significantly less time compared with the quadscan technique. By using the disclosed solutions, coupling of the charging artifacts and artifacts caused by other factors (e.g., scan directions, geometric features, or actual artifacts) may be minimized.

Relative dimensions of components in drawings may be exaggerated for clarity. Within the following description of drawings, the same or like reference numbers refer to the same or like components or entities, and only the differences with respect to the individual embodiments are described.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

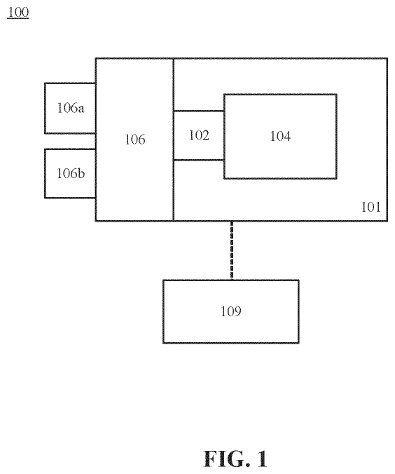

FIG. 1 illustrates an exemplary charged-particle beam inspection (CPBI) system 100 consistent with some embodiments of the present disclosure. CPBI system 100 may be used for imaging. For example, CPBI system 100 may use an electron beam for imaging. As shown in FIG. 1, CPBI system 100 includes a main chamber 101, a load/lock chamber 102, a beam tool 104, and an equipment front end module (EFEM) 106. Beam tool 104 is located within main chamber 101. EFEM 106 includes a first loading port 106a and a second loading port 106b. EFEM 106 may include additional loading port(s). First loading port 106a and second loading port 106b receive wafer front opening unified pods (FOUPs) that contain wafers (e.g., semiconductor wafers or wafers made of other material(s)) or samples to be inspected (wafers and samples may be used interchangeably). A “lot” is a plurality of wafers that may be loaded for processing as a batch.

One or more robotic arms (not shown) in EFEM 106 may transport the wafers to load/lock chamber 102. Load/lock chamber 102 is connected to a load/lock vacuum pump system (not shown) which removes gas molecules in load/lock chamber 102 to reach a first pressure below the atmospheric pressure. After reaching the first pressure, one or more robotic arms (not shown) may transport the wafer from load/lock chamber 102 to main chamber 101. Main chamber 101 is connected to a main chamber vacuum pump system (not shown) which removes gas molecules in main chamber 101 to reach a second pressure below the first pressure. After reaching the second pressure, the wafer is subject to inspection by beam tool 104. Beam tool 104 may be a single-beam system or a multi-beam system.

A controller 109 is electronically connected to beam tool 104. Controller 109 may be a computer that may execute various controls of CPBI system 100. While controller 109 is shown in FIG. 1 as being outside of the structure that includes main chamber 101, load/lock chamber 102, and EFEM 106, it is appreciated that controller 109 may be a part of the structure.

In some embodiments, controller 109 may include one or more processors (not shown). A processor may be a generic or specific electronic device capable of manipulating or processing information. For example, the processor may include any combination of any number of a central processing unit (or “CPU”), a graphics processing unit (or “GPU”), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), and any type circuit capable of data processing. The processor may also be a virtual processor that includes one or more processors distributed across multiple machines or devices coupled via a network.

In some embodiments, controller 109 may further include one or more memories (not shown). A memory may be a generic or specific electronic device capable of storing codes and data accessible by the processor (e.g., via a bus). For example, the memory may include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or any type of storage device. The codes may include an operating system (OS) and one or more application programs (or “apps”) for specific tasks. The memory may also be a virtual memory that includes one or more memories distributed across multiple machines or devices coupled via a network.

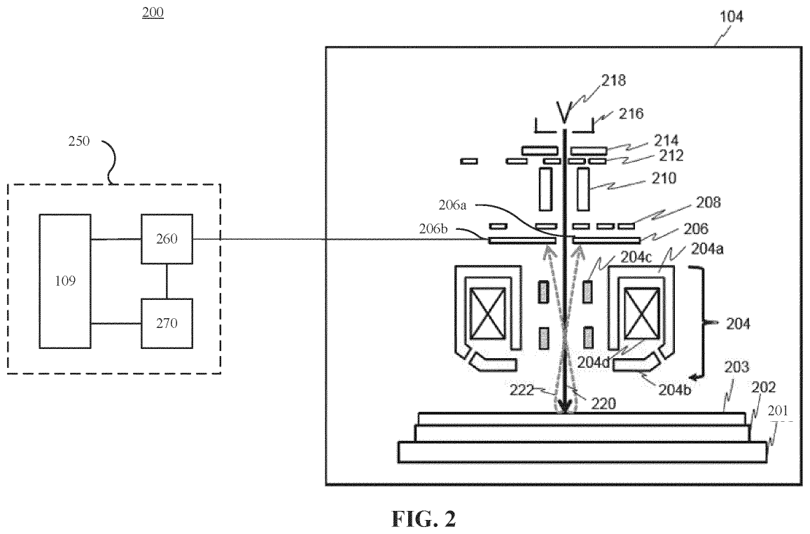

FIG. 2 illustrates an example imaging system 200 according to embodiments of the present disclosure. Beam tool 104 of FIG. 2 may be configured for use in CPBI system 100. Beam tool 104 may be a single beam apparatus or a multi-beam apparatus. As shown in FIG. 2, beam tool 104 includes a motorized sample stage 201, and a wafer holder 202 supported by motorized sample stage 201 to hold a wafer 203 to be inspected. Beam tool 104 further includes an objective lens assembly 204, a charged-particle detector 206 (which includes charged-particle sensor surfaces 206a and 206b), an objective aperture 208, a condenser lens 210, a beam limit aperture 212, a gun aperture 214, an anode 216, and a cathode 218. Objective lens assembly 204, in some embodiments, may include a modified swing objective retarding immersion lens (SORIL), which includes a pole piece 204a, a control electrode 204b, a deflector 204c, and an exciting coil 204d. Beam tool 104 may additionally include an Energy Dispersive X-ray Spectrometer (EDS) detector (not shown) to characterize the materials on wafer 203.

A primary charged-particle beam 220 (or simply “primary beam 220”), such as an electron beam, is emitted from cathode 218 by applying an acceleration voltage between anode 216 and cathode 218. Primary beam 220 passes through gun aperture 214 and beam limit aperture 212, both of which may determine the size of charged-particle beam entering condenser lens 210, which resides below beam limit aperture 212. Condenser lens 210 focuses primary beam 220 before the beam enters objective aperture 208 to set the size of the charged-particle beam before entering objective lens assembly 204. Deflector 204c deflects primary beam 220 to facilitate beam scanning on the wafer. For example, in a scanning process, deflector 204c may be controlled to deflect primary beam 220 sequentially onto different locations of top surface of wafer 203 at different time points, to provide data for image reconstruction for different parts of wafer 203. Moreover, deflector 204c may also be controlled to deflect primary beam 220 onto different sides of wafer 203 at a particular location, at different time points, to provide data for stereo image reconstruction of the wafer structure at that location. Further, in some embodiments, anode 216 and cathode 218 may generate multiple primary beams 220, and beam tool 104 may include a plurality of deflectors 204c to project the multiple primary beams 220 to different parts/sides of the wafer at the same time, to provide data for image reconstruction for different parts of wafer 203.

Exciting coil 204d and pole piece 204a generate a magnetic field that begins at one end of pole piece 204a and terminates at the other end of pole piece 204a. A part of wafer 203 being scanned by primary beam 220 may be immersed in the magnetic field and may be electrically charged, which, in turn, creates an electric field. The electric field reduces the energy of impinging primary beam 220 near the surface of wafer 203 before it collides with wafer 203. Control electrode 204b, being electrically isolated from pole piece 204a, controls an electric field on wafer 203 to prevent micro-arching of wafer 203 and to ensure proper beam focus.

A secondary charged-particle beam 222 (or “secondary beam 222”), such as secondary electron beams, may be emitted from the part of wafer 203 upon receiving primary beam 220. Secondary beam 222 may form a beam spot on sensor surfaces 206a and 206b of charged-particle detector 206. Charged-particle detector 206 may generate a signal (e.g., a voltage, a current, or the like.) that represents an intensity of the beam spot and provide the signal to an image processing system 250. The intensity of secondary beam 222, and the resultant beam spot, may vary according to the external or internal structure of wafer 203. Moreover, as discussed above, primary beam 220 may be projected onto different locations of the top surface of the wafer or different sides of the wafer at a particular location, to generate secondary beams 222 (and the resultant beam spot) of different intensities. Therefore, by mapping the intensities of the beam spots with the locations of wafer 203, the processing system may reconstruct an image that reflects the internal or surface structures of wafer 203.

Imaging system 200 may be used for inspecting a wafer 203 on motorized sample stage 201 and includes beam tool 104, as discussed above. Imaging system 200 may also include an image processing system 250 that includes an image acquirer 260, storage 270, and controller 109. Image acquirer 260 may include one or more processors. For example, image acquirer 260 may include a computer, server, mainframe host, terminals, personal computer, any kind of mobile computing devices, and the like, or a combination thereof. Image acquirer 260 may connect with a detector 206 of beam tool 104 through a medium such as an electrical conductor, optical fiber cable, portable storage media, IR, Bluetooth, internet, wireless network, wireless radio, or a combination thereof. Image acquirer 260 may receive a signal from detector 206 and may construct an image. Image acquirer 260 may thus acquire images of wafer 203. Image acquirer 260 may also perform various post-processing functions, such as generating contours, superimposing indicators on an acquired image, and the like. Image acquirer 260 may perform adjustments of brightness and contrast, or the like, of acquired images. Storage 270 may be a storage medium such as a hard disk, cloud storage, random access memory (RAM), other types of computer readable memory, and the like. Storage 270 may be coupled with image acquirer 260 and may be used for saving scanned raw image data as original images, post-processed images, or other images assisting of the processing. Image acquirer 260 and storage 270 may be connected to controller 109. In some embodiments, image acquirer 260, storage 270, and controller 109 may be integrated together as one control unit.

In some embodiments, image acquirer 260 may acquire one or more images of a sample based on an imaging signal received from detector 206. An imaging signal may correspond to a scanning operation for conducting charged particle imaging. An acquired image may be a single image including a plurality of imaging areas. The single image may be stored in storage 270. The single image may be an original image that may be divided into a plurality of regions. Each of the regions may include one imaging area containing a feature of wafer 203.

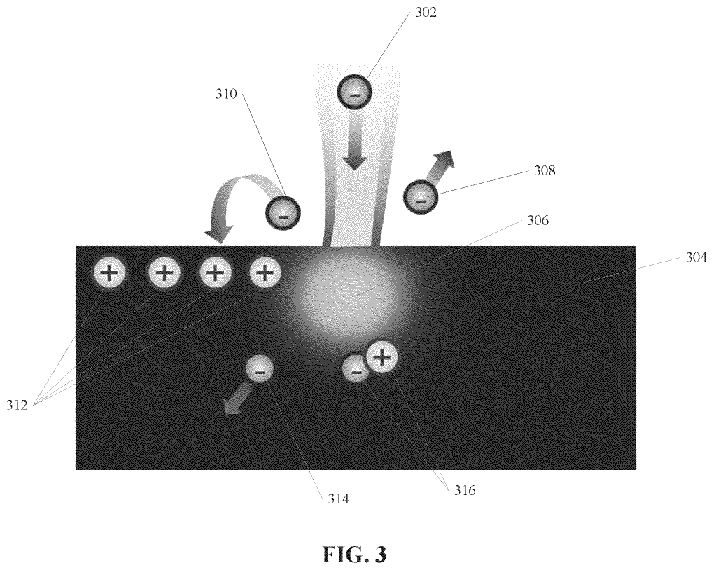

FIG. 3 is a schematic diagram illustrating an example process of a charging effect induced by a charged-particle beam tool (e.g., a scanning charged-particle microscope), consistent with some embodiments of the present disclosure. A scanning charged-particle microscope (“SCPM”) generates a primary charged-particle beam (e.g., primary charged-particle beam 220 in FIG. 2) for inspection. For example, the primary charged-particle beam may be a primary electron beam. In FIG. 3, electrons of a primary electron beam 302 are projected onto a surface of insulator sample 304. Insulator sample 304 may be of insulating materials, such as a non-conductive resist, a silicon dioxide layer, or the like.

The electrons of primary electron beam 302 may penetrate the surface of insulator sample 304 for a certain depth (e.g., several nanometers), interacting with particles of insulator sample 304 in interaction volume 306. Some electrons of primary electron beam 302 may elastically interact with (e.g., in a form of elastic scattering or collision) the particles in interaction volume 306 and may be reflected or recoiled out of the surface of insulator sample 304. An elastic interaction conserves the total kinetic energies of the bodies (e.g., electrons of primary electron beam 302 and particles of insulator sample 304) of the interaction, in which no kinetic energy of the interacting bodies convert to other forms of energy (e.g., heat, electromagnetic energy, etc.). Such reflected electrons generated from elastic interaction may be referred to as backscattered electrons (BSEs), such as BSE 308 in FIG. 3. Some electrons of primary electron beam 302 may inelastically interact with (e.g., in a form of inelastic scattering or collision) the particles in interaction volume 306. An inelastic interaction does not conserve the total kinetic energies of the bodies of the interaction, in which some or all of the kinetic energy of the interacting bodies may covert to other forms of energy. For example, through the inelastic interaction, the kinetic energy of some electrons of primary electron beam 302 may cause electron excitation and transition of atoms of the particles. Such inelastic interaction may also generate electrons exiting the surface of insulator sample 304, which may be referred to as secondary electrons (SEs), such as SE 310 in FIG. 3. Yield or emission rates of BSEs and SEs may depend on, for example, the energy of the electrons of primary electron beam 302 and the material under inspection, among other factors. The energy of the electrons of primary electron beam 302 may be imparted in part by its acceleration voltage (e.g., the acceleration voltage between anode 216 and cathode 218 in FIG. 2). The quantity of BSEs and SEs may be more or fewer (or even the same) than the injected electrons of primary electron beam 302. An imbalance of incoming and outgoing electrons can cause accumulation of electric charge (e.g., positive or negative charge) on the surface of insulator sample 304. Because insulator sample 304 is non-conductive and cannot be grounded, the extra charge may build up locally on or near the surface of insulator sample 304, which may be referred to as a SCPM-induced (e.g., SEM-induced) charging effect.

Typically, insulating materials (e.g., many types of resists) may be positively charged, because the outgoing electrons (e.g., BSEs or SEs) typically exceeds the incoming electrons of the primary electron beam of a SEM, and extra positive charge builds up on or near the surface of the insulator material. FIG. 3 shows a case where the SEM-induced charging effect occurs and causes positive charge accumulated on the surface of insulator sample 304. The positive charge may be physically modelled as holes 312. In FIG. 3, the electrons of primary electron beam 302 injected into interaction volume 306 may diffuse to the neighboring volume of interaction volume 306, which may be referred to as diffused electrons, such as diffused charge 314. The diffused electrons may recombine with positive charge (e.g., holes 312) in insulator sample 304, such as recombination pair 316. The diffusion and recombination of charge may affect the distribution of holes 312. Holes 312 may cause a problem by, for example, attracting BSEs and SEs back to the surface of insulator sample 304, increasing the landing energy of the electrons of primary electron beam 302, causing the electrons of primary electron beam 302 to deviate from their intended landing spot, or interfering with an electric field between the surface of insulator sample 304 and an electron detector of BSEs and SEs, such as electron detector 206 in FIG. 2.

The SCPM-induced charging effect may attenuate and distort the SCPM signals received by the electron detector, which may further distort generated SCPM images. Also, because insulator sample 304 is non-conductive, as primary electron beam 302 scans across its surface, positive charge may be accumulated along the path of primary electron beam 302. Such accumulation of positive charge may increase or complicate the distortion in the generated SEM images. Such distortion caused by the SCPM-induced charging effect may be referred to as SCPM-induced charging artifacts. The SCPM-induced charging artifacts may induce error in estimating geometrical size of fabricated structures or cause misidentification of defects in an inspection.

With reference to FIG. 3 as an example, the surface of insulator sample 304 may include various features, such as lines, slots, corners, edges, holes, or the like. Those features may be at different heights. When primary electron beam 302 scans across a feature that has a height change, especially a sudden height change, SEs may be generated and collected from the surface, and additionally from an edge or even a hidden surface (e.g., a sidewall of the edge) of the feature. Those additional SEs may cause brighter edges or contours in the SEM image. Such an effect may be referred to as “edge enhancement” or “edge blooming.” The SEM-induced charging effect may also be aggravated due to the escape of the additional SEs (i.e., leaving additional positive charge on the sample surface). The aggravated charging effect may cause different charging artifacts in edge bloom regions of the SEM image, depending on whether the height of the surface elevates or lowers as primary electron beam 302 scans by. A contour identification technique may be applied to identify one or more contours in the SEM image. The identified contours indicate locations of edge blooms (i.e., regions with additional positive charge).

Consistent with some embodiments of this disclosure, a computer-implemented method for reducing charging artifacts in an inspection image is disclosed. In some embodiments, the inspection image may be an image of a structure (e.g., an integrated circuit) fabricated on a sample (e.g., a wafer die). An inspection image, as used herein, may refer to an image generated as a result of an inspection process performed by a charged-particle inspection apparatus (e.g., system 100 of FIG. 1 or system 200 of FIG. 2). For example, an inspection image may be a SEM image generated by image processing system 250 in FIG. 2. A fabricated structure in this disclosure may refer to a structure manufactured on a sample (e.g., a wafer) in a semiconductor manufacturing process (e.g., a photolithography process). For example, the fabricated structure may be manufactured in a die of the sample.

The computer-implemented method may include obtaining a set of inspection images, in which each of the set of inspection images may include a charging artifact. The obtaining, as used herein, may refer to accepting, taking in, admitting, gaining, acquiring, retrieving, receiving, reading, accessing, collecting, or any operation for inputting data. In some embodiments, the set of inspection images may be measured inspection images. For example, the set of inspection images may be obtained by performing multiple scans on a test sample (e.g., being the same as or different from the sample). Each of the multiple scans may use a different acquisition setting. By way of example, the acquisition setting may include at least one of a beam current, a scan direction, or a landing energy of a beam.

In some embodiments, the set of inspection images may be simulated inspection images. To generate the set of inspection images, in some embodiments, the method may include generating a set of simulated inspection images. In some embodiments, each of the set of simulated inspection images may include a charging artifact, and accordingly, the set of simulated inspection images may be used as the set of inspection images directly.

In some embodiments, each of the set of inspection images may include no charging artifact. In such cases, the set of simulated inspection images may be generated using a Monte-Carlo based technique (e.g., a Monte-Carlo SEM simulator). In some embodiments, the Monte-Carlo based technique may simulate a ray trace of a charged-particle (e.g., an electron) incident into a sample (e.g., a structure on wafer), ray traces of one or more secondary charged-particle (e.g., secondary electrons) coming out of the sample as a result of an interaction between the incident charged-particle and atoms of the sample, as well as parameters (e.g., energy, momentum, or any other energetic or kinematic features) of the incident charged-particle and the secondary charged-particles. The Monte-Carlo based technique may further simulate interactions between the secondary charged-particles and materials of a detector (e.g., detector 206 in FIG. 2) of the charged-particle inspection apparatus, and simulate a graphical representation of an inspection image generated by the detector as a result of the interactions between the secondary charged-particles and the materials of the detector. Such a simulated graphical representation may be a simulation image.

After generating the set of simulated inspection images that include no charging artifacts, the computer-implemented method may also include generating the set of inspection images by applying a physics-based model to the set of simulated inspection images. In some embodiments, the physics-based model may simulate the charging effect based on parameters (e.g., charge density, incident angles, scan directions, scan speeds, doses, charge diffusion time, or the like) associated with incident charged particles. Based on such parameters, the physics-based model may determine interaction features (e.g., Coulomb forces, local barrier potentials, or the like) that may affect trajectory of secondary electrons or backscattered electrons. By way of example, if the secondary electrons have a potential lower than a calculated local barrier potential, then the secondary electrons may be deemed as non-escapable, which may reduce the secondary electron yield and affect the simulation results.

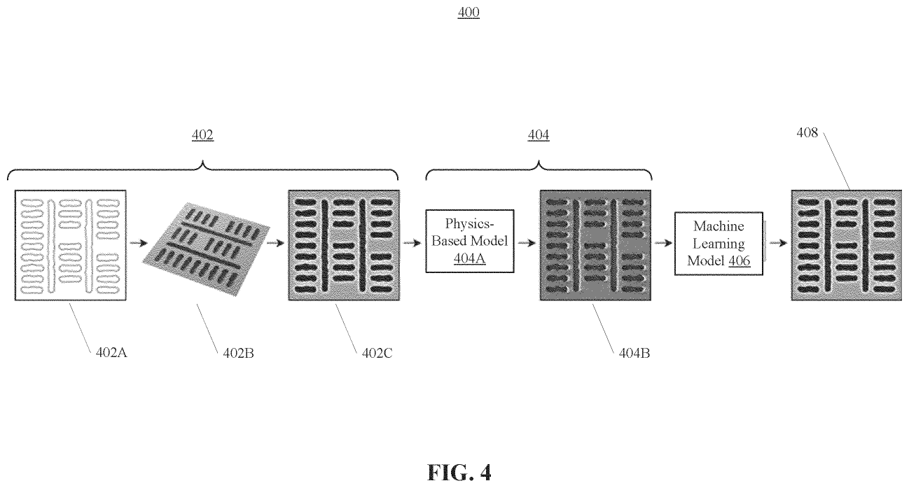

By way of example, FIG. 4 is a schematic diagram illustrating an example process 400 for reducing charging artifacts in an inspection image, consistent with some embodiments of the present disclosure. Process 400 includes stages 402, 404, and 408. At stage 402, a seed contour 402A may be used as input to a Monte-Carlo SEM simulator for generating a simulated inspection image. For example, seed contour 402A may be generated based on design data (e.g., a GDSII design layout). As illustrated in FIG. 4, seed contour 402A include multiple patterns, such as horizontal lines and vertical lines. Based on seed contour 402A, a three-dimensional finite element mesh 402B may be generated by a meshing program. The meshing program may be independent of or part of the Monte-Carlo SEM simulator. Based on mesh 402B, the Monte-Carlo SEM simulator may generate a simulated inspection image 402C. Simulated inspection image 402C does not include any charging artifacts, represented by edge blooming (e.g., white shades surrounding the patterns) in simulated inspection image 402C.

At stage 404, simulated inspection image 402C may be input to a physics-based model 404A (e.g., a forward charging model) to generate a simulated inspection image 404B. Simulated inspection image 404B includes charging artifacts, represented by edge blooming (e.g., white shades on the right of the patterns) in simulated inspection image 404B.

Consistent with some embodiments of this disclosure, the computer-implemented method may also include training a machine learning model using the set of inspection images as input. The machine learning model may output a set of decoupled features of the set of inspection images. Decoupled features, as used herein, may refer to features disentangled from, separate from, independent of, or with no interrelationship between each other, in which a value of a first feature has no correlation or little correlation from a value of a second feature. By way of example, with reference to FIG. 4, after stage 404, simulated inspection image 404B may be inputted to a machine learning model 406 to train machine learning model 406. In some embodiments, the machine learning model may include an autoencoder, and the set of decoupled features may include a set of codes of the autoencoder.

An autoencoder in this disclosure may refer to a type of a neural network model (or simply a “neural network”). A neural network, as used herein, may refer to a computing model for analyzing underlying relationships in a set of input data by way of mimicking human brains. Similar to a biological neural network, the neural network may include a set of connected units or nodes (referred to as “neurons”), structured as different layers, where each connection (also referred to as an “edge”) may obtain and send a signal between neurons of neighboring layers in a way similar to a synapse in a biological brain. The signal may be any type of data (e.g., a real number). Each neuron may obtain one or more signals as an input and output another signal by applying a non-linear function to the inputted signals. Neurons and edges may typically be weighted by corresponding weights to represent the knowledge the neural network has acquired. During a training process (similar to a learning process of a biological brain), the weights may be adjusted (e.g., by increasing or decreasing their values) to change the strengths of the signals between the neurons to improve the performance accuracy of the neural network. Neurons may apply a thresholding function (referred to as an “activation function”) to its output values of the non-linear function such that a signal is outputted only when an aggregated value (e.g., a weighted sum) of the output values of the non-linear function exceeds a threshold determined by the thresholding function. Different layers of neurons may transform their input signals in different manners (e.g., by applying different non-linear functions or activation functions). The output of the last layer (referred to as an “output layer”) may output the analysis result of the neural network, such as, for example, a categorization of the set of input data (e.g., as in image recognition cases), a numerical result, or any type of output data for obtaining an analytical result from the input data.

Training of the neural network, as used herein, may refer to a process of improving the accuracy of the output of the neural network. Typically, the training may be categorized into three types: supervised training, unsupervised training, and reinforcement training. In the supervised training, a set of target output data (also referred to as “labels” or “ground truth”) may be generated based on a set of input data using a method other than the neural network. The neural network may then be fed with the set of input data to generate a set of output data that is typically different from the target output data. Based on the difference between the output data and the target output data, the weights of the neural network may be adjusted in accordance with a rule. If such adjustments are successful, the neural network may generate another set of output data more similar to the target output data in a next iteration using the same input data. If such adjustments are not successful, the weights of the neural network may be adjusted again. After a sufficient number of iterations, the training process may be terminated in accordance with one or more predetermined criteria (e.g., the difference between the final output data and the target output data is below a predetermined threshold, or the number of iterations reaches a predetermined threshold). The trained neural network may be applied to analyze other input data.

In the unsupervised training, the neural network is trained without any external gauge (e.g., labels) to identify patterns in the input data rather than generating labels for them. Typically, the neural network may analyze shared attributes (e.g., similarities and differences) and relationships among the elements of the input data in accordance with one or more predetermined rules or algorithms (e.g., principal component analysis, clustering, anomaly detection, or latent variable identification). The trained neural network may extrapolate the identified relationships to other input data.

In the reinforcement learning, the neural network is trained without any external gauge (e.g., labels) in a trial-and-error manner to maximize benefits in decision making. The input data sets of the neural network may be different in the reinforcement training. For example, a reward value or a penalty value may be determined for the output of the neural network in accordance with one or more rules during training, and the weights of the neural network may be adjusted to maximize the reward values (or to minimize the penalty values). The trained neural network may apply its learned decision-making knowledge to other input data.

During the training of a neural network, a loss function (or referred to as a “cost function”) may be used to evaluate the output data. The loss function, as used herein, may map output data of a machine learning model (e.g., the neural network) onto a real number (referred to as a “loss” or a “cost”) that intuitively represents a loss or an error (e.g., representing a difference between the output data and target output data) associated with the output data. The training of the neural network may seek to maximize or minimize the loss function (e.g., by pushing the loss towards a local maximum or a local minimum in a loss curve). For example, one or more parameters of the neural network may be adjusted or updated purporting to maximize or minimize the loss function. After adjusting or updating the one or more parameters, the neural network may obtain new input data in a next iteration of its training. When the loss function is maximized or minimized, the training of the neural network may be terminated.

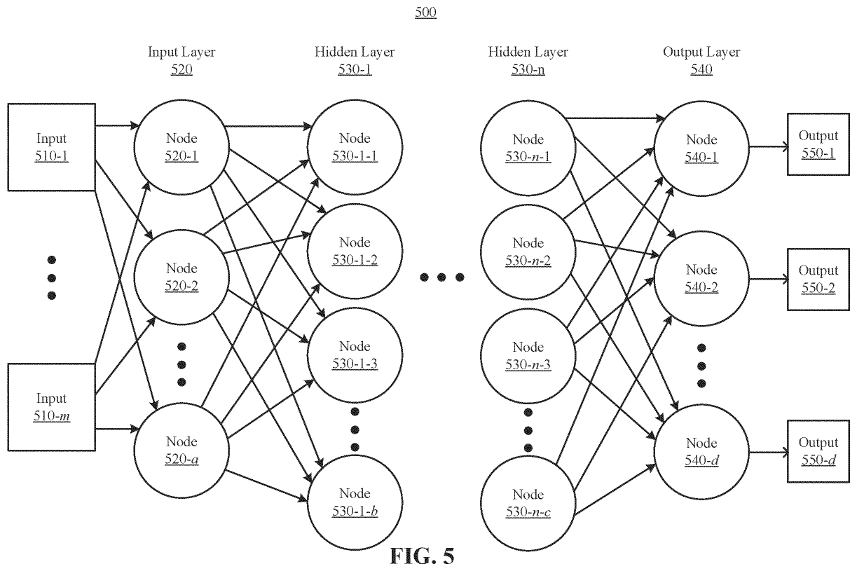

By way of example, FIG. 5 is a schematic diagram illustrating an example neural network 500, consistent with some embodiments of the present disclosure. As depicted in FIG. 5, neural network 500 may include an input layer 520 that receives inputs, including input 510-1, . . . , input 510-m (m being an integer). For example, an input of neural network 500 may include any structure or unstructured data (e.g., an image). In some embodiments, neural network 500 may obtain a plurality of inputs simultaneously. For example, in FIG. 5, neural network 500 may obtain m inputs simultaneously. In some embodiments, input layer 520 may obtain m inputs in succession such that input layer 520 receives input 510-1 in a first cycle (e.g., in a first inference) and pushes data from input 510-1 to a hidden layer (e.g., hidden layer 530-1), then receives a second input in a second cycle (e.g., in a second inference) and pushes data from input the second input to the hidden layer, and so on. Input layer 520 may obtain any number of inputs in the simultaneous manner, the successive manner, or any manner of grouping the inputs.

Input layer 520 may include one or more nodes, including node 520-1, node 520-2, . . . , node 520-a (a being an integer). A node (also referred to as a “machine perception” or a “neuron”) may model the functioning of a biological neuron. Each node may apply an activation function to received inputs (e.g., one or more of input 510-1, . . . , input 510-m). An activation function may include a Heaviside step function, a Gaussian function, a multiquadratic function, an inverse multiquadratic function, a sigmoidal function, a rectified linear unit (ReLU) function (e.g., a ReLU6 function or a Leaky ReLU function), a hyperbolic tangent (“tanh”) function, or any non-linear function. The output of the activation function may be weighted by a weight associated with the node. A weight may include a positive value between 0 and 1, or any numerical value that may scale outputs of some nodes in a layer more or less than outputs of other nodes in the same layer.

As further depicted in FIG. 5, neural network 500 includes multiple hidden layers, including hidden layer 530-1, . . . , hidden layer 530-n (n being an integer). When neural network 500 includes more than one hidden layer, it may be referred to as a “deep neural network” (DNN). Each hidden layer may include one or more nodes. For example, in FIG. 5, hidden layer 530-1 includes node 530-1-1, node 530-1-2, node 530-1-3, . . . , node 530-1-b (b being an integer), and hidden layer 530-n includes node 530-n-1, node 530-n-2, node 530-n-3, . . . , node 530-n-c (c being an integer). Similar to nodes of input layer 520, nodes of the hidden layers may apply the same or different activation functions to outputs from connected nodes of a previous layer, and weight the outputs from the activation functions by weights associated with the nodes.

As further depicted in FIG. 5, neural network 500 may include an output layer 540 that finalizes outputs, including output 550-1, output 550-2, . . . , output 550-d (d being an integer). Output layer 540 may include one or more nodes, including node 540-1, node 540-2, . . . , node 540-d. Similar to nodes of input layer 520 and of the hidden layers, nodes of output layer 540 may apply activation functions to outputs from connected nodes of a previous layer and weight the outputs from the activation functions by weights associated with the nodes.

Although nodes of each hidden layer of neural network 500 are depicted in FIG. 5 to be connected to each node of its previous layer and next layer (referred to as “fully connected”), the layers of neural network 500 may use any connection scheme. For example, one or more layers (e.g., input layer 520, hidden layer 530-1, . . . , hidden layer 530-n, or output layer 540) of neural network 500 may be connected using a convolutional scheme, a sparsely connected scheme, or any connection scheme that uses fewer connections between one layer and a previous layer than the fully connected scheme as depicted in FIG. 5.

Moreover, although the inputs and outputs of the layers of neural network 500 are depicted as propagating in a forward direction (e.g., being fed from input layer 520 to output layer 540, referred to as a “feedforward network”) in FIG. 5, neural network 500 may additionally or alternatively use backpropagation (e.g., feeding data from output layer 540 towards input layer 520) for other purposes. For example, the backpropagation may be implemented by using long short-term memory nodes (LSTM). Accordingly, although neural network 500 is depicted similar to a convolutional neural network (CNN), neural network 500 may include a recurrent neural network (RNN) or any other neural network.

An autoencoder in this disclosure may include an encoder sub-model (or simply “encoder”) and a decoder sub-model (or simply “decoder”), in which both the encoder and the decoder are symmetric neural networks. The encoder of the autoencoder may obtain input data and output a compressed representation (also referred to as a “latent code” or simply a “code” herein) of the input data. The code of the input data may include extracted features of the input data. For example, the code may include a feature vector, a feature map, a feature matrix, a pixelated feature image, or any form of data representing the extracted features of the input data. During training, the decoder of the autoencoder may obtain the code outputted by the encoder and output decoded data. The goal of training the autoencoder may be to minimize the difference between the input data and the decoded data. After the training is completed, in an application of the trained autoencoder (referred to as an “inference stage”), input data may be fed to the encoder to generate a code, and the decoder of the autoencoder is not used. The code may be used as purposed output data or as feature-extracted data for other applications (e.g., for training a different machine learning model).

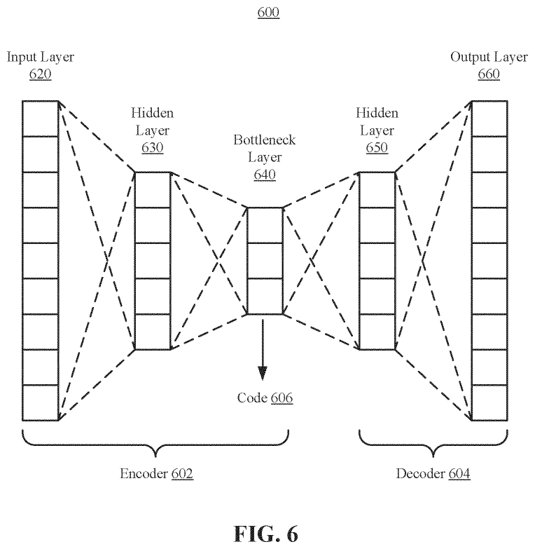

By way of example, FIG. 6 is a schematic diagram illustrating an example autoencoder 600, consistent with some embodiments of the present disclosure. As depicted in FIG. 6, autoencoder 600 includes an encoder 602 and a decoder 604. Both encoder 602 and decoder 604 are neural networks (e.g., similar to neural network 500 in FIG. 5). Encoder 602 includes an input layer 620 (e.g., similar to input layer 520 in FIG. 5), a hidden layer 630 (e.g., similar to hidden layer 530-1 in FIG. 5), and a bottleneck layer 640. Bottleneck layer 640 may function as an output layer (e.g., similar to output layer 540 in FIG. 5) of encoder 602. It should be noted that encoder 602 may include one or more hidden layers (besides hidden layer 630) and is not limited to the example embodiments as illustrated and described in association with FIG. 6. Decoder 604 includes a hidden layer 650 (e.g., similar to hidden layer 530-1 in FIG. 5) and an output layer 660 (e.g., similar to output layer 540 in FIG. 5). Bottleneck layer 640 may function as an input layer (e.g., similar to input layer 520 in FIG. 5) of decoder 604. It should be noted that decoder 604 may include one or more hidden layers (besides hidden layer 650) and is not limited to the example embodiments as illustrated and described in association with FIG. 6. The dash lines between layers of autoencoder 640 in FIG. 6 represents example connections between neurons of adjacent layers.

As depicted in FIG. 6, the structure of encoder 602 and the structure of decoder 604 are symmetric (e.g., being similar in a reverse order). For example, hidden layer 630 may include the same number (e.g., 4) of neurons as hidden layer 650, and input layer 620 may include the same number (e.g., 9) of neurons as output layer 660. Also, the connections between neurons of input layer 620 and neurons of hidden layer 630 may be symmetric with the connections between neurons of hidden layer 650 and neurons of output layer 660, and the connections between the neurons of hidden layer 630 and neurons of bottleneck layer 640 may be symmetric with the connections between the neurons of bottleneck layer 640 and the neurons of hidden layer 650.

As depicted in FIG. 6, encoder 602 may receive input data (not shown in FIG. 6) at input layer 620 and output a compressed representation of the input data at bottleneck layer 640. The compressed representation is referred to as code 606 in FIG. 6. For example, code 606 may include a feature vector, a feature map, a feature matrix, a pixelated feature image, or any form of data representing the extracted features of the input data. Decoder 604 may receive code 606 at hidden layer 650 and output decoded data (not shown in FIG. 6) at output layer 660. During the training of autoencoder 600, a difference between the decoded data and the input data may be minimized. After completing the training of autoencoder 600, encoder 602 may be used in a reference stage. Non-training data may be input to encoder 602 to generate code 606 that is a compressed representation of the non-training data. Code 606 outputted by encoder 602 in a reference stage may be used as purposed output data or as feature-extracted data for other applications (e.g., for training a different machine learning model).

In some embodiments, the set of decoupled features outputted by the machine learning model described herein may include at least one of a feature representing a scan direction, a feature representing a pattern, or a feature representing a dose of charged particles. For example, if the machine learning model is an autoencoder (e.g., autoencoder 600), the set of decoupled features may be a set of codes (e.g., code 606) that include at least one of a code representing a scan direction, a code representing a pattern, or a code representing a dose of charged particles.

Consistent with some embodiments of this disclosure, the computer-implemented method may further include applying the trained machine learning model on the inspection image to generate an output inspection image. The output inspection image may include fewer charging artifacts than the inspection image. By way of example, with reference to FIG. 4, machine learning model 406 may be applied to an inspection image (not shown in FIG. 4) to generate an output inspection image 408 to reduce charging artifacts in the inspection image.

In some embodiments, the machine learning model may include an autoencoder (e.g., autoencoder 600 of FIG. 6). The set of decoupled features may include a set of codes (e.g., code 606 described in association with FIG. 6) of the autoencoder. The set of codes may include at least one of a code representing a scan direction, a code representing a pattern feature, or a code representing a dose of charged particles. In such embodiments, to generate the output inspection image, an encoder (e.g., encoder 602 described in association with FIG. 6) of the trained autoencoder may be applied on the inspection image to generate the set of codes. Then, the code representing the dose of charged particles may be set to a value of zero. After that, a decoder (e.g., decoder 604 described in association with FIG. 6) of the trained autoencoder may be applied to the set of codes to generate the output inspection image, in which the set of codes may include the changed code representing the dose of charged particles.

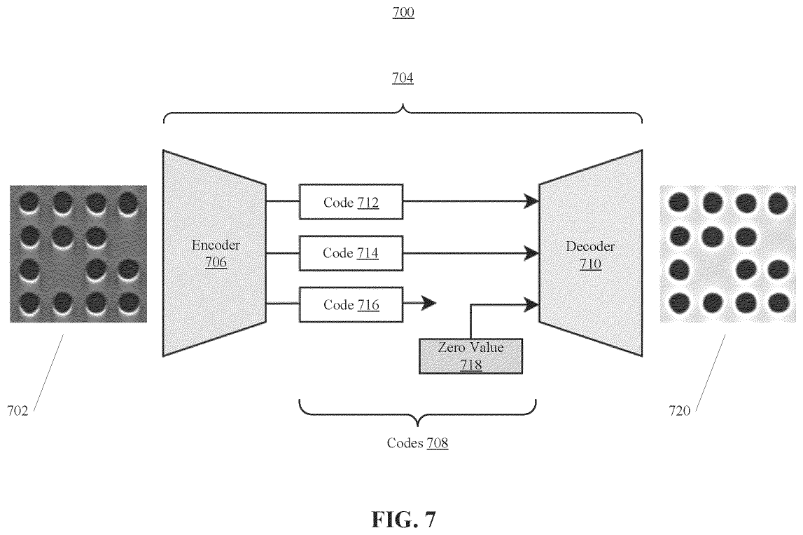

By way of example, FIG. 7 is a schematic diagram illustrating an example process 700 for reducing charging artifacts in an inspection image 702 using a trained autoencoder 704, consistent with some embodiments of the present disclosure. As depicted in FIG. 7, inspection image 702 may be obtained in an actual measurement and not in a simulation. Inspection image 702 includes multiple patterns (represented by black round holes). The patterns present charging artifacts (represented by the white shades at the lower half of the black round holes). Such charging artifacts may deteriorate the performance of an edge detection algorithm, and further affect the defect detection of inspection image 702.

As depicted in FIG. 7, autoencoder 704 includes an encoder 706 and a decoder 710. Encoder 706 may obtain inspection image 702 as input and output codes 708. Codes 708 include a code 712 representing a pattern feature (e.g., the patterns represented by black round holes in inspection image 702), a code 714 representing a scan direction, and a code 716 representing a dose of charged particles incident on the sample during the scan. As depicted in FIG. 7, after generating codes 708, code 716 may be changed to a zero value 718. Decoder 710 may be applied to codes 708 (except that code 716 having been changed to zero value 718) to generate an output image 720. Charging artifacts in output image 720 may be less or eliminated compared with inspection image 702.

In some embodiments, the output inspection image may include a pattern having a surrounding edge blooming. For example, the surrounding edge blooming may exist in all direction of the pattern and enclose the pattern. The surrounding edge blooming may also have substantially the same strength (e.g., with at most 5% fluctuation) in all direction of the pattern. By way of example, with reference to FIG. 7, each pattern in output image 720 has a surrounding edge blooming (represented by white shades that respectively enclose each black round hole). With the fewer charging artifacts, output image 720 may be used for edge detection of its patterns, which may generate more accurate results.

In some embodiments, the machine learning model (e.g., autoencoder 704) may be trained using a domain adaptation technique. A domain, as used herein, may refer to a rendering, a feature space, or a setting for presenting data. A domain adaptation technique, as used herein, may refer to a machine learning model (e.g., an autoencoder) or statistical model that may translate inputted data from a source domain to a target domain. The source domain and the target domain may share common data features but have different distributions or representations of the common data features. In some embodiments, the domain adaptation technique may include a cycle-consistent domain adaptation technique. For example, the cycle-consistent domain adaptation technique may translate an image of a sample in a full color space (e.g., in a real-world color space) into the same image in a grayscale color space (e.g., under a perspective of SEM), in which the image of the sample is the inputted data, the source domain is the full color space, and the target domain is the grayscale color space. The cycle consistency, as used herein, may refer to a characteristic of a domain adaptation technique in which the domain adaptation technique may bidirectionally and indistinguishably translate data between a source domain and a target domain. For example, a cycle-consistent domain adaptation technique (e.g., an autoencoder) may obtain first data (e.g., a first image of a sample) in the source domain (e.g., in the full color space) and output second data (e.g., a second image of the same or similar sample) in the target domain (e.g., in the grayscale color space), and may also receive the second data and output third data (e.g., a third image of the same or similar sample) in the source domain, in which the third data is indistinguishable from the first data. By application of the cycle-consistent domain adaptation technique to clean-looking simulated SEM inspection images, object-dependent image features (e.g., brightness, contrast, or the like) may be changed, such as by including stronger and asymmetrical edge blooming effects, to convert the clean-looking simulated SEM images to be more realistic-looking SEM images (e.g., more similar to measured SEM inspection images). Similarly, by application of the cycle-consistent domain adaptation technique to the converted more realistic-looking SEM images, the clean-looking simulated SEM inspection images may be reproduced.

In some embodiments, the set of inspection images described herein may include a first simulated inspection image, a second simulated inspection image, a third simulated inspection image, and a fourth simulated inspection image. The first simulated inspection image and the second simulated inspection image may have a same pattern feature and different charging properties (e.g., scan directions). The third simulated inspection image and the fourth simulated inspection image may have different pattern features. In some embodiments, in addition to different pattern features, the third simulated inspection image and the fourth simulated inspection image may have the same or different charging properties (e.g., scan directions). To train the machine learning model, in response to obtaining the first simulated inspection image and the second simulated inspection image, an encoder of the autoencoder may be applied on the first simulated inspection image to generate a first set of codes and be applied on the second simulated inspection image to generate a second set of codes. Then, in response to obtaining the third simulated inspection image and the fourth simulated inspection image, the encoder may be applied on the third simulated inspection image to generate a third set of codes and applied on the fourth simulated inspection image to generate a fourth set of codes. After that, the autoencoder may be trained based on the first set of codes, the second set of codes, the third set of codes, and the fourth set of codes.

In some embodiments, the first set of codes may include a first code representing a first pattern feature of the first simulated inspection image. The second set of codes may include a second code representing a second pattern feature of the second simulated inspection image. The third set of codes may include a third code representing a first dose of charged particles associated with the third simulated inspection image. The fourth set of codes may include a fourth code representing a second dose of charged particles associated with the fourth simulated inspection image. In such a scenario, to train the autoencoder based on the first set of codes, the second set of codes, the third set of codes, and the fourth set of codes, the first code and the second code may be swapped to generate a first updated set of codes and a second updated set of codes, in which the first updated set of codes includes the second code, and the second updated set of codes includes the first code. Then, the third code may be set to be a first random value to generate a third updated set of codes, and the fourth code may be set to be a second random value to generate a fourth updated set of codes. After that, the autoencoder may be trained based on the first updated set of codes, the second updated set of codes, the third updated set of codes, and the fourth updated set of codes.

In some embodiments, to train the autoencoder based on the first updated set of codes, the second updated set of codes, the third updated set of codes, and the fourth updated set of codes, a loss function may be determined based on the first updated set of codes and the second updated set of codes. Then, a decoder of the autoencoder may be applied to the third updated set of codes to generate a first intermediate output image and applied to the fourth updated set of codes to generate a second intermediate output image. The encoder may be applied on the first intermediate output image to generate a fifth set of codes and applied on the second intermediate output image to generate a sixth set of codes. The fifth set of codes may include a fifth code representing a third dose of charged particles associated with the first intermediate output image. The sixth set of codes may include a sixth code representing a fourth dose of charged particles associated with the second intermediate output image. Then, the loss function may be updated based on a first difference and a second difference, in which the first difference is between a value of the third code and a value of the fifth code, and the second difference is between a value of the fourth code and a value of the sixth code. After that, the autoencoder may be trained using the updated loss function.

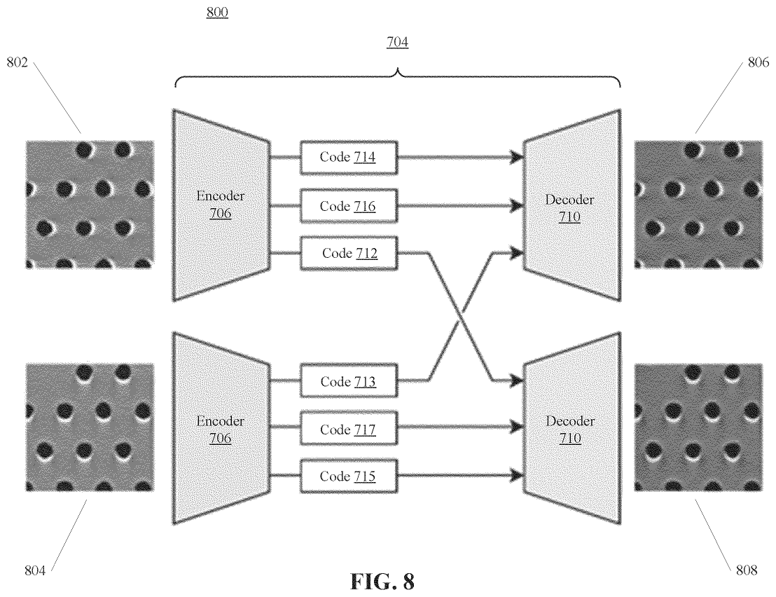

By way of example, FIG. 8 is a schematic diagram illustrating an example process 800 for training autoencoder 704 of FIG. 7, consistent with some embodiments of the present disclosure. As illustrated in FIG. 8, autoencoder 704 includes encoder 706 and decoder 710. During a training stage, in response to obtaining a first simulated inspection image 802, encoder 706 may be applied on first simulated inspection image 802 to generate a first set of codes that include code 712 representing a pattern feature (e.g., the patterns represented by black round holes in first simulated inspection image 802), code 714 representing a scan direction (e.g., a rightward direction), and code 716 representing a dose of charged particles incident on a sample corresponding to first simulated inspection image 802 during the scan. In response to obtaining a second simulated inspection image 804, encoder 706 may also be applied on second simulated inspection image 804 to generate a second set of codes that include a code 713 representing a pattern feature (e.g., the patterns represented by black round holes in second simulated inspection image 804), a code 715 representing a scan direction (e.g., a downward direction), and a code 717 representing a dose of charged particles incident on a sample corresponding to second simulated inspection image 804 during the scan. First simulated inspection image 802 and second simulated inspection image 804 may be generated using a Monte-Carlo based technique (e.g., by stage 402 described in association with FIG. 4) and a physics-based model (e.g., by stage 404 described in association with FIG. 4) as described herein. First simulated inspection image 802 and second simulated inspection image 804 include charging artifacts (represented by white shades on the right of the patterns and at the bottom of the patterns, respectively). As depicted in FIG. 8, first simulated inspection image 802 and second simulated inspection image 804 have the same pattern feature (e.g., both represented by black round holes) and different scan directions. The scan direction of first simulated inspection image 802 may be a rightward direction, and the scan direction of second simulated inspection image 804 may be a downward direction.

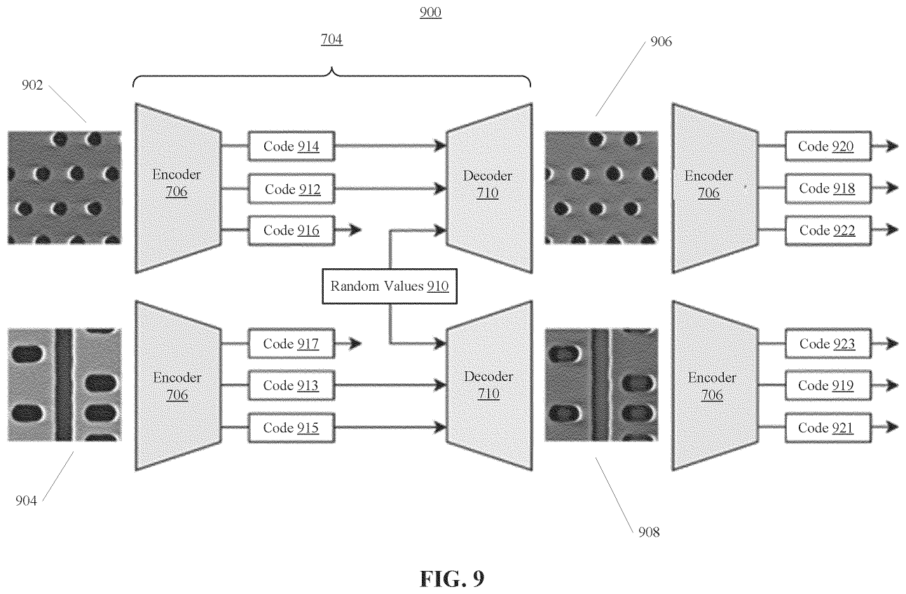

By way of example, FIG. 9 is a schematic diagram illustrating an example process 900 for training autoencoder 704 of FIG. 7, consistent with some embodiments of the present disclosure. In some embodiments, process 900 may be performed in combination with process 800 for training autoencoder 704.

As illustrated in FIG. 9, autoencoder 704 includes encoder 706 and decoder 710. During a training stage, in response to obtaining a third simulated inspection image 902, encoder 706 may be applied on third simulated inspection image 902 to generate a third set of codes that include a code 912 representing a pattern feature (e.g., the patterns represented by black round holes in third simulated inspection image 902), a code 914 representing a scan direction (e.g., a rightward direction), and a code 916 representing a dose of charged particles incident on a sample corresponding to third simulated inspection image 902 during the scan. In response to obtaining a fourth simulated inspection image 904, encoder 706 may also be applied on a fourth simulated inspection image 904 to generate a fourth set of codes that include a code 913 representing a pattern feature (e.g., the patterns represented by black round holes in fourth simulated inspection image 904), a code 915 representing a scan direction (e.g., a downward direction), and a code 917 representing a dose of charged particles incident on a sample corresponding to fourth simulated inspection image 904 during the scan. Third simulated inspection image 902 and fourth simulated inspection image 904 may be generated using a Monte-Carlo based technique (e.g., by stage 402 described in association with FIG. 4) and a physics-based model (e.g., by stage 404 described in association with FIG. 4) as described herein. Third simulated inspection image 902 and fourth simulated inspection image 904 include charging artifacts (represented by white shades on the left of the patterns and on the right of the patterns, respectively). As depicted in FIG. 9, third simulated inspection image 902 and fourth simulated inspection image 904 have different pattern features and different scan directions. The feature patterns of third simulated inspection image 902 are represented by black round holes, and the feature patterns of fourth simulated inspection image 904 are represented by horizontal or vertical black bars. The scan direction of third simulated inspection image 902 may be a leftward direction, and the scan direction of fourth simulated inspection image 904 may be a rightward direction. It should be noted that the scan directions of third simulated inspection image 902 and fourth simulated inspection image 904 may be the same or different.

With reference to FIGS. 8-9, autoencoder 704 may be trained based on the first set of codes, the second set of codes, the third set of codes, and the fourth set of codes. As illustrated in FIG. 8, code 712 and code 713 may be swapped to generate a first updated set of codes and a second updated set of codes, in which the first updated set of codes includes code 713, code 714, and code 716, and the second updated set of codes includes code 712, code 715, and code 717. As illustrated in FIG. 9, code 916 and code 917 may be set to have random values. The random values may be selected from random values 910 (e.g., random values generated using a Gaussian random number generator), as an example. For example, code 916 may be set to have a first random value selected from random values 910, and code 917 may be set to have a second random value selected from random values 910.

With reference to FIGS. 8-9, autoencoder 704 may be trained based on the first updated set of codes, the second updated set of codes, the third updated set of codes, and the fourth updated set of codes. With reference to FIG. 8, after swapping code 712 and code 713, a loss function may be determined based on the first updated set of codes and the second updated set of codes.

With reference to FIG. 9, after setting code 916 and code 917 to be random values, decoder 710 may be applied to the third updated set of codes (that includes code 912, code 914, and code 916 having the first random value) to generate a first intermediate output image 906. Decoder 710 may be applied to the fourth updated set of codes (that includes code 913, code 915, and code 917 having the second random value) to generate a second intermediate output image 908. Then, encoder 706 may be applied on first intermediate output image 906 to generate a fifth set of codes and applied on second intermediate output image 908 to generate a sixth set of codes. The fifth set of codes may include a code 918 representing a pattern feature, a code 920 representing a scan direction, and a code 922 representing a dose of charged particles incident on a sample corresponding to first intermediate output image 906. Encoder 706 may also be applied on second intermediate output image 908 to generate a sixth set of codes. The sixth set of codes may include a code 919 representing a pattern feature, a code 921 representing a scan direction, and a code 923 representing a dose of charged particles incident on a sample corresponding to second intermediate output image 908.

After generating the fifth set of codes and the sixth set of codes as described in association with FIG. 9, the loss function determined in process 800 of FIG. 8 may be updated based on a determination that a first difference exceeds a first threshold value (e.g., 0, 0.01, 0.2, or any value) and a determination that a second difference exceeds a second threshold value (e.g., 0, 0.01, 0.2, or any value). The first difference may be between a value of code 922 and a value of code 916 that has the first random value. The second difference may be between a value of code 923 and a value of code 917 that has the second random value. The first threshold value may be the same as or different from the second random value. After that, autoencoder 704 may be trained using the updated loss function. For example, if the updated loss function outputs a loss value that satisfies a condition (e.g., being greater than or equal to a threshold, or smaller than or equal to the threshold), one or more parameters of at least one of encoder 706 or decoder 710 may be updated, and the updated autoencoder 704 may be inputted with new simulated inspection images again to generate new intermediate output images in a similar manner as described in association with FIGS. 8-9. When the loss function outputs a loss value that does not satisfy the condition, the training process (e.g., including process 800 and process 900) of autoencoder 704 may be deemed completed. By performing training process 800 and process 900 as described herein, autoencoder 704 may decouple the codes representing pattern features (e.g., code 712 and code 713) from codes representing other features (e.g., code 714, code 715, code 716, and code 717) of the simulated inspection image (e.g., first simulated inspection image 802 and second simulated inspection image 804), and may further be enabled to manipulate the codes (e.g., code 916 and code 917) representing doses of charged particles of the simulated inspection image (e.g., third simulated inspection image 902 and fourth simulated inspection image 904) to generate corresponding intermediate output images (e.g., first intermediate output image 906 and second intermediate output image 908) independent from inputted simulated inspection images. Such manipulation may be performed without affecting other features (e.g., features representing pattern features or scan directions) of the inputted simulated inspection image.

After completing the training processes described in association with process 800 and process 900, a trained autoencoder 704 may be used to be applied on actual inspection images for reducing charging artifacts therein, such as in accordance with process 700 described herein.

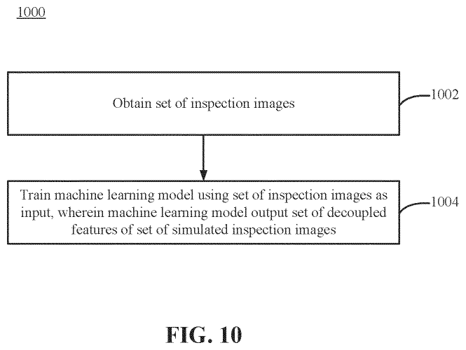

By way of example, FIG. 10 is a flowchart illustrating an example method 1000 for reducing charging artifacts in an inspection image, consistent with some embodiments of the present disclosure. Method 1000 may be performed by a controller that may be coupled with a charged-particle beam tool (e.g., charged-particle beam inspection system 100) or an optical beam tool. For example, the controller may be controller 109 in FIG. 2. The controller may be programmed to implement method 1000.

At step 1002, the controller may obtain a set of inspection images. Each of the set of inspection images may include a charging artifact. In some embodiments, the set of inspection images may be measured inspection images, and the controller may obtain the set of inspection images by performing multiple scans on a test sample. Each of the multiple scans may use a different acquisition setting. The acquisition setting may include at least one of a beam current, a scan direction, or a landing energy of a beam.

In some embodiments, the set of inspection images may be simulated inspection images. To obtain the set of inspection images, the controller may generate a set of simulated inspection images (e.g., simulated inspection image 402C of FIG. 4). In some embodiments, the controller may generate the set of simulated inspection images as the set of inspection images, in which each of the set of simulated inspection images may include a charging artifact.

In some embodiments, each of the set of inspection images includes no charging artifact. In such cases, the controller may generate the set of inspection images by applying a physics-based model (e.g., physics-based model 404A of FIG. 4) to the set of simulated inspection images. In some embodiments, the controller may generate the set of simulated inspection images using a Monte-Carlo based technique.

At step 1004, the controller may train a machine learning model using the set of inspection images as input. The machine learning model may output a set of decoupled features of the set of inspection images. In some embodiments, the machine learning model may include an autoencoder (e.g., autoencoder 704 described in association with FIGS. 7-9), and the set of decoupled features may include a set of codes (e.g., codes 712-717 described in association with FIGS. 7-9) of the autoencoder.

In some embodiments, the set of decoupled features may include at least one of a feature representing a scan direction, a feature representing a pattern, or a feature representing a dose of charged particles. For example, when the machine learning model may include an autoencoder, the set of decoupled features may include a set of codes of the autoencoder, and the set of codes may include at least one of a code representing a scan direction (e.g., code 714 or code 715 described in association with FIGS. 7-9), a code representing a pattern feature (e.g., code 712 or code 713 described in association with FIGS. 7-9), or a code representing a dose of charged particles (e.g., code 716 or code 717 described in association with FIGS. 7-9).

In some embodiments, the set of inspection images may include a first simulated inspection image (e.g., first simulated inspection image 802 of FIG. 8), a second simulated inspection image (e.g., second simulated inspection image 804 of FIG. 8), a third simulated inspection image (e.g., third simulated inspection image 902 of FIG. 9), and a fourth simulated inspection image (e.g., fourth simulated inspection image 904 of FIG. 9). The first simulated inspection image and the second simulated inspection image have a same pattern feature and different scan directions. The third simulated inspection image and the fourth simulated inspection image may have different pattern features. To train the machine learning model, in response to obtaining the first simulated inspection image and the second simulated inspection image, the controller may apply an encoder (e.g., encoder 706 described in association with FIG. 8) of the autoencoder on the first simulated inspection image to generate a first set of codes (e.g., including code 712, code 714, and code 716 described in association with FIG. 8) and on the second simulated inspection image to generate a second set of codes (e.g., including code 713, code 715, and code 717 described in association with FIG. 8). In response to obtaining the third simulated inspection image and the fourth simulated inspection image, the controller may apply the encoder (e.g., encoder 706 described in association with FIG. 9) on the third simulated inspection image to generate a third set of codes (e.g., including code 912, code 914, and code 916 described in association with FIG. 9) and on the fourth simulated inspection image to generate a fourth set of codes (e.g., including code 913, code 915, and code 917 described in association with FIG. 9). Then, the controller may train the autoencoder based on the first set of codes, the second set of codes, the third set of codes, and the fourth set of codes.

In some embodiments, the first set of codes may include a first code (e.g., code 712 of FIG. 8) representing a first pattern feature of the first simulated inspection image. The second set of codes may include a second code (e.g., code 713 of FIG. 8) representing a second pattern feature of the second simulated inspection image. The third set of codes may include a third code (e.g., code 916 of FIG. 9) representing a first dose of charged particles associated with the first simulated inspection image. The fourth set of codes may include a fourth code (e.g., code 917 of FIG. 9) representing a second dose of charged particles associated with the second simulated inspection image. To train the autoencoder based on the first set of codes, the second set of codes, the third set of codes, and the fourth set of codes, the controller may swap the first code and the second code to generate a first updated set of codes that include the second code (e.g., code 713 of FIG. 8) and a second updated set of codes that include the first code (e.g., code 712 of FIG. 8). For example, with reference to FIG. 8, the first updated set of codes may include code 713, code 714, and code 716, and on the second updated set of codes may include code 712, code 715, and code 717. Then, the controller may set the third code to be a first random value (e.g., being selected from random values 910 of FIG. 9) to generate a third updated set of codes, and set the fourth code to be a second random value (e.g., being selected from random values 910 of FIG. 9) to generate a fourth updated set of codes. After that, the controller may train the autoencoder based on the first updated set of codes, the second updated set of codes, the third updated set of codes, and the fourth updated set of codes.

In some embodiments, to train the autoencoder based on the first updated set of codes, the second updated set of codes, the third updated set of codes, and the fourth updated set of codes, the controller may determine a loss function based on the first updated set of codes and the second updated set of codes. Then, the controller may apply a decoder (e.g., decoder 710 described in association with FIGS. 7-9) of the autoencoder to the third updated set of codes to generate a first intermediate output image (e.g., first intermediate output image 906 of FIG. 9) and to the fourth updated set of codes to generate a second intermediate output image (e.g., second intermediate output image 908 of FIG. 9). The controller may also apply the encoder on the first intermediate output image to generate a fifth set of codes (e.g., including code 918, code 920, and code 922 in FIG. 9) and on the second intermediate output image to generate a sixth set of codes (e.g., including code 919, code 921, and code 923 in FIG. 9). The fifth set of codes may include a fifth code (e.g., code 922 in FIG. 9) representing a third dose of charged particles associated with the first intermediate output image, and the sixth set of codes may include a sixth code (e.g., code 923 in FIG. 9) representing a fourth dose of charged particles associated with the second intermediate output image. The controller may further update the loss function based on a determination that a first difference exceeds a first threshold value and a determination that a second difference exceeds a second threshold value, in which the first difference may be between a value of the third code (e.g., code 916) and a value of the fifth code (e.g., code 922), and the second difference may be between a value of the fourth code (e.g., code 917) and a value of the sixth code (e.g., code 923). After that, the controller may train the autoencoder using the updated loss function.

Consistent with some embodiments of this disclosure, besides steps 1002-1004, the controller may further apply the trained machine learning model on the inspection image (e.g., inspection image 702 of FIG. 7) to generate an output inspection image (e.g., output image 720 of FIG. 7), in which the output inspection image may include fewer charging artifacts than the inspection image. In some embodiments, the output inspection image may include a pattern having a surrounding edge blooming (e.g., the surrounding edge blooming described in association with output image 720).

In some embodiments, when the machine learning model includes an autoencoder (e.g., autoencoder 704 described in association with FIGS. 7-9), the set of decoupled features may include a set of codes of the autoencoder, and the set of codes may include at least one of a code representing a scan direction, a code representing a pattern feature, or a code representing a dose of charged particles. To generate the output inspection image, the controller may apply an encoder (e.g., encoder 706 described in association with FIG. 7) of the trained autoencoder on the inspection image (e.g., inspection image 702 of FIG. 7) to generate the set of codes (e.g., code 712, code 714, and code 716 of FIG. 7). Then, the controller may set the code (e.g., code 716 of FIG. 7) representing the dose of charged particles to a value of zero (e.g., zero value 718 of FIG. 7). After that, the controller may apply a decoder (e.g., decoder 710 described in association with FIG. 7) of the trained autoencoder to the set of codes to generate the output inspection image (e.g., output image 720 of FIG. 7), in which the set of codes may include the changed code representing the dose of charged particles.

A non-transitory computer readable medium may be provided that stores instructions for a processor (for example, processor of controller 109 of FIG. 1) to carry out image processing such as method 1000 of FIG. 10, data processing, database management, graphical display, operations of an image inspection apparatus or another imaging device, detecting a defect on a sample, or the like. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The embodiments can further be described using the following clauses:
1. A system, comprising:
an image inspection apparatus configured to scan a sample and generate an inspection image of an integrated circuit fabricated on the sample; and
a controller including circuitry, configured to:
generate a set of simulated inspection images, wherein each of the set of simulated inspection images comprises no charging artifact; and
generate a set of inspection images by applying a physics-based model to the set of simulated inspection images;
train a machine learning model using the set of inspection images as input, wherein the machine learning model outputs a set of decoupled features of the set of inspection images; and
apply the trained machine learning model on the inspection image to generate an output inspection image, wherein the output inspection image comprises fewer charging artifacts than the inspection image.
2. A system, comprising:
an image inspection apparatus configured to scan a sample and generate an inspection image of an integrated circuit fabricated on the sample; and
a controller including circuitry, configured to:
obtain a set of inspection images, wherein each of the set of inspection images comprises a charging artifact; and
train a machine learning model using the set of inspection images as input, wherein the machine learning model outputs a set of decoupled features of the set of inspection images.
3. The system of clause 2, wherein the set of inspection images are measured inspection images, and wherein the controller includes circuitry further configured to:
obtain the set of inspection images by performing multiple scans on a test sample, wherein each of the multiple scans is configured to use a different acquisition setting, and the acquisition setting comprises at least one of a beam current, a scan direction, or a landing energy of a beam.
4. The system of clause 2, wherein the set of inspection images are simulated inspection images, and wherein the controller includes circuitry further configured to:
generate a set of simulated inspection images, wherein each of the set of simulated inspection images comprises no charging artifact; and
generate the set of inspection images by applying a physics-based model to the set of simulated inspection images.
5. The system of clause 4, wherein the controller includes circuitry further configured to generate the set of simulated inspection images using a Monte-Carlo based technique.
6. The system of clause 2, wherein the set of inspection images are simulated inspection images, and wherein the controller includes circuitry further configured to:
generate a set of simulated inspection images as the set of inspection images, wherein each of the set of simulated inspection images comprises a charging artifact.
7. The system of any of clauses 2-6, wherein the set of decoupled features comprise at least one of a feature representing a scan direction, a feature representing a pattern, or a feature representing a dose of charged particles.
8. The system of any of clauses 2-7, wherein the controller includes circuitry further configured to: apply the trained machine learning model on the inspection image to generate an output inspection image, wherein the output inspection image comprises fewer charging artifacts than the inspection image.
9. The system of clause 8, wherein the output inspection image comprises a pattern having a surrounding edge blooming.
10. The system of any of clauses 8-9, wherein the machine learning model comprises an autoencoder, the set of decoupled features comprise a set of codes of the autoencoder, and the set of codes comprise at least one of a code representing a scan direction, a code representing a pattern feature, or a code representing a dose of charged particles.
11. The system of clause 10, wherein the controller includes circuitry further configured to: apply an encoder of the trained autoencoder on the inspection image to generate the set of codes; set the code representing the dose of charged particles to a value of zero; and apply a decoder of the trained autoencoder to the set of codes to generate the output inspection image, wherein the set of codes comprise the changed code representing the dose of charged particles.
12. The system of any of clauses 2-9, wherein the machine learning model comprises an autoencoder, and the set of decoupled features comprise a set of codes of the autoencoder.
13. The system of clause 12, wherein the set of inspection images comprise a first simulated inspection image, a second simulated inspection image, a third simulated inspection image, and a fourth simulated inspection image, wherein the first simulated inspection image and the second simulated inspection image have a same pattern feature and different scan directions, wherein the third simulated inspection image and the fourth simulated inspection image have different pattern features, and wherein the controller includes circuitry further configured to:
in response to obtaining the first simulated inspection image and the second simulated inspection image, apply an encoder of the autoencoder on the first simulated inspection image to generate a first set of codes and on the second simulated inspection image to generate a second set of codes;
in response to obtaining the third simulated inspection image and the fourth simulated inspection image, apply the encoder on the third simulated inspection image to generate a third set of codes and on the fourth simulated inspection image to generate a fourth set of codes; and
train the autoencoder based on the first set of codes, the second set of codes, the third set of codes, and the fourth set of codes.
14. The system of clause 13, wherein the first set of codes comprises a first code representing a first pattern feature of the first simulated inspection image, the second set of codes comprises a second code representing a second pattern feature of the second simulated inspection image, the third set of codes comprises a third code representing a first dose of charged particles associated with the third simulated inspection image, and the fourth set of codes comprises a fourth code representing a second dose of charged particles associated with the fourth simulated inspection image, and wherein the controller includes circuitry further configured to:
swap the first code and the second code to generate a first updated set of codes comprising the second code and a second updated set of codes comprising the first code;
set the third code to be a first random value to generate a third updated set of codes and the fourth code to be a second random value to generate a fourth updated set of codes;
train the autoencoder based on the first updated set of codes, the second updated set of codes, the third updated set of codes, and the fourth updated set of codes.
15. The system of clause 14, wherein the controller includes circuitry further configured to: determine a loss function based on the first updated set of codes and the second updated set of codes;
apply a decoder of the autoencoder to the third updated set of codes to generate a first intermediate output image and to the fourth updated set of codes to generate a second intermediate output image;
apply the encoder on the first intermediate output image to generate a fifth set of codes and on the second intermediate output image to generate a sixth set of codes, wherein the fifth set of codes comprises a fifth code representing a third dose of charged particles associated with the first intermediate output image, and the sixth set of codes comprises a sixth code representing a fourth dose of charged particles associated with the second intermediate output image;
update the loss function based on a determination that a first difference exceeds a first threshold value and a determination that a second difference exceeds a second threshold value, wherein the first difference is between a value of the third code and a value of the fifth code, and the second difference is between a value of the fourth code and a value of the sixth code; and
train the autoencoder using the updated loss function.
16. A non-transitory computer-readable medium that stores a set of instructions that is executable by at least one processor of an apparatus to cause the apparatus to perform a method, the method comprising:
generating a set of simulated inspection images, wherein each of the set of simulated inspection images comprises no charging artifact; and
generating a set of inspection images by applying a physics-based model to the set of simulated inspection images;
training a machine learning model using the set of inspection images as input, wherein the machine learning model outputs a set of decoupled features of the set of inspection images; and
applying the trained machine learning model on an inspection image to generate an output inspection image, wherein the output inspection image comprises fewer charging artifacts than the inspection image.
17. A non-transitory computer-readable medium that stores a set of instructions that is executable by at least one processor of an apparatus to cause the apparatus to perform a method, the method comprising:
obtaining a set of inspection images, wherein each of the set of inspection images comprises a charging artifact; and
training a machine learning model using the set of inspection images as input, wherein the machine learning model outputs a set of decoupled features of the set of inspection images.
18. The non-transitory computer-readable medium of clause 17, wherein the set of inspection images are measured inspection images, and wherein obtaining the set of inspection images comprises:
obtaining the set of inspection images by performing multiple scans on a test sample, wherein each of the multiple scans is configured to use a different acquisition setting, and the acquisition setting comprises at least one of a beam current, a scan direction, or a landing energy of a beam.
19. The non-transitory computer-readable medium of clause 17, wherein the set of inspection images are simulated inspection images, and wherein obtaining the set of inspection images comprises:
generating a set of simulated inspection images, wherein each of the set of simulated inspection images comprises no charging artifact; and
generating the set of inspection images by applying a physics-based model to the set of simulated inspection images.
20. The non-transitory computer-readable medium of clause 19, wherein the method further comprises generating the set of simulated inspection images using a Monte-Carlo based technique.
21. The non-transitory computer-readable medium of clause 17, wherein the set of inspection images are simulated inspection images, and wherein obtaining the set of inspection images comprises:
generating a set of simulated inspection images as the set of inspection images, wherein each of the set of simulated inspection images comprises a charging artifact.
22. The non-transitory computer-readable medium of any of clauses 17-21, wherein the set of decoupled features comprise at least one of a feature representing a scan direction, a feature representing a pattern, or a feature representing a dose of charged particles.
23. The non-transitory computer-readable medium of any of clauses 17-22, wherein the method further comprises:
applying the trained machine learning model on an inspection image to generate an output inspection image, wherein the output inspection image comprises fewer charging artifacts than the inspection image.
24. The non-transitory computer-readable medium of clause 23, wherein the output inspection image comprises a pattern having a surrounding edge blooming.
25. The non-transitory computer-readable medium of any of clauses 23-24, wherein the machine learning model comprises an autoencoder, the set of decoupled features comprise a set of codes of the autoencoder, and the set of codes comprise at least one of a code representing a scan direction, a code representing a pattern feature, or a code representing a dose of charged particles.
26. The non-transitory computer-readable medium of clause 25, wherein applying the trained machine learning model on the inspection image to generate the output inspection image comprises:
applying an encoder of the trained autoencoder on the inspection image to generate the set of codes; setting the code representing the dose of charged particles to a value of zero; and
applying a decoder of the trained autoencoder to the set of codes to generate the output inspection image, wherein the set of codes comprise the changed code representing the dose of charged particles.
27. The non-transitory computer-readable medium of any of clauses 17-24, wherein the machine learning model comprises an autoencoder, and the set of decoupled features comprise a set of codes of the autoencoder.
28. The non-transitory computer-readable medium of clause 27, wherein the set of inspection images comprise a first simulated inspection image, a second simulated inspection image, a third simulated inspection image, and a fourth simulated inspection image, wherein the first simulated inspection image and the second simulated inspection image have a same pattern feature and different scan directions, wherein the third simulated inspection image and the fourth simulated inspection image have different pattern features, and wherein training the machine learning model comprises:
in response to obtaining the first simulated inspection image and the second simulated inspection image, applying an encoder of the autoencoder on the first simulated inspection image to generate a first set of codes and on the second simulated inspection image to generate a second set of codes;
in response to obtaining the third simulated inspection image and the fourth simulated inspection image, applying the encoder on the third simulated inspection image to generate a third set of codes and on the fourth simulated inspection image to generate a fourth set of codes; and
training the autoencoder based on the first set of codes, the second set of codes, the third set of codes, and the fourth set of codes.
29. The non-transitory computer-readable medium of clause 28, wherein the first set of codes comprises a first code representing a first pattern feature of the first simulated inspection image, the second set of codes comprises a second code representing a second pattern feature of the second simulated inspection image, the third set of codes comprises a third code representing a first dose of charged particles associated with the third simulated inspection image, and the fourth set of codes comprises a fourth code representing a second dose of charged particles associated with the fourth simulated inspection image, and wherein training the autoencoder based on the first set of codes, the second set of codes, the third set of codes, and the fourth set of codes comprises:
swapping the first code and the second code to generate a first updated set of codes comprising the second code and a second updated set of codes comprising the first code;
setting the third code to be a first random value to generate a third updated set of codes and the fourth code to be a second random value to generate a fourth updated set of codes;
training the autoencoder based on the first updated set of codes, the second updated set of codes, the third updated set of codes, and the fourth updated set of codes.
30. The non-transitory computer-readable medium of clause 29, wherein training the autoencoder based on the first updated set of codes, the second updated set of codes, the third updated set of codes, and the fourth updated set of codes comprises:
determining a loss function based on the first updated set of codes and the second updated set of codes;
applying a decoder of the autoencoder to the third updated set of codes to generate a first intermediate output image and to the fourth updated set of codes to generate a second intermediate output image;
applying the encoder on the first intermediate output image to generate a fifth set of codes and on the second intermediate output image to generate a sixth set of codes, wherein the fifth set of codes comprises a fifth code representing a third dose of charged particles associated with the first intermediate output image, and the sixth set of codes comprises a sixth code representing a fourth dose of charged particles associated with the second intermediate output image;
updating the loss function based on a determination that a first difference exceeds a first threshold value and a determination that a second difference exceeds a second threshold value, wherein the first difference is between a value of the third code and a value of the fifth code, and the second difference is between a value of the fourth code and a value of the sixth code; and
training the autoencoder using the updated loss function.
31. A computer-implemented method for reducing charging artifacts in an inspection image, the computer-implemented method comprising:
generating a set of simulated inspection images, wherein each of the set of simulated inspection images comprises no charging artifact; and
generating a set of inspection images by applying a physics-based model to the set of simulated inspection images;
training a machine learning model using the set of inspection images as input, wherein the machine learning model outputs a set of decoupled features of the set of inspection images; and
applying the trained machine learning model on the inspection image to generate an output inspection image, wherein the output inspection image comprises fewer charging artifacts than the inspection image.
32. A computer-implemented method for reducing charging artifacts in an inspection image, the computer-implemented method comprising:
obtaining a set of inspection images, wherein each of the set of inspection images comprises a charging artifact; and
training a machine learning model using the set of inspection images as input, wherein the machine learning model outputs a set of decoupled features of the set of inspection images.
33. The computer-implemented method of clause 32, wherein the set of inspection images are measured inspection images, and wherein obtaining the set of inspection images comprises:
obtaining the set of inspection images by performing multiple scans on a test sample, wherein each of the multiple scans is configured to use a different acquisition setting, and the acquisition setting comprises at least one of a beam current, a scan direction, or a landing energy of a beam.
34. The computer-implemented method of clause 32, wherein the set of inspection images are simulated inspection images, and wherein obtaining the set of inspection images comprises:
generating a set of simulated inspection images, wherein each of the set of simulated inspection images comprises no charging artifact; and
generating the set of inspection images by applying a physics-based model to the set of simulated inspection images.
35. The computer-implemented method of clause 34, wherein the computer-implemented method further comprises generating the set of simulated inspection images using a Monte-Carlo based technique.
36. The computer-implemented method of any of clauses 32-35, wherein the set of inspection images are simulated inspection images, and wherein obtaining the set of inspection images comprises:
generating a set of simulated inspection images as the set of inspection images, wherein each of the set of simulated inspection images comprises a charging artifact.
37. The computer-implemented method of any of clauses 32-36, wherein the set of decoupled features comprise at least one of a feature representing a scan direction, a feature representing a pattern, or a feature representing a dose of charged particles.
38. The computer-implemented method of any of clauses 32-37, further comprising:
applying the trained machine learning model on the inspection image to generate an output inspection image, wherein the output inspection image comprises fewer charging artifacts than the inspection image.
39. The computer-implemented method of clause 38, wherein the output inspection image comprises a pattern having a surrounding edge blooming.
40. The computer-implemented method of any of clauses 38-39, wherein the machine learning model comprises an autoencoder, the set of decoupled features comprise a set of codes of the autoencoder, and
the set of codes comprise at least one of a code representing a scan direction, a code representing a pattern feature, or a code representing a dose of charged particles.
41. The computer-implemented method of clause 40, wherein applying the trained machine learning model on the inspection image to generate the output inspection image comprises:
applying an encoder of the trained autoencoder on the inspection image to generate the set of codes; setting the code representing the dose of charged particles to a value of zero; and
applying a decoder of the trained autoencoder to the set of codes to generate the output inspection image, wherein the set of codes comprise the changed code representing the dose of charged particles.
42. The computer-implemented method of any of clauses 32-39, wherein the machine learning model comprises an autoencoder, and the set of decoupled features comprise a set of codes of the autoencoder.
43. The computer-implemented method of clause 42, wherein the set of inspection images comprise a first simulated inspection image, a second simulated inspection image, a third simulated inspection image, and a fourth simulated inspection image, wherein the first simulated inspection image and the second simulated inspection image have a same pattern feature and different scan directions, wherein the third simulated inspection image and the fourth simulated inspection image have different pattern features, and wherein training the machine learning model comprises:
in response to obtaining the first simulated inspection image and the second simulated inspection image, applying an encoder of the autoencoder on the first simulated inspection image to generate a first set of codes and on the second simulated inspection image to generate a second set of codes;
in response to obtaining the third simulated inspection image and the fourth simulated inspection image, applying the encoder on the third simulated inspection image to generate a third set of codes and on the fourth simulated inspection image to generate a fourth set of codes; and
training the autoencoder based on the first set of codes, the second set of codes, the third set of codes, and the fourth set of codes.
44. The computer-implemented method of clause 43, wherein the first set of codes comprises a first code representing a first pattern feature of the first simulated inspection image, the second set of codes comprises a second code representing a second pattern feature of the second simulated inspection image, the third set of codes comprises a third code representing a first dose of charged particles associated with the third simulated inspection image, and the fourth set of codes comprises a fourth code representing a second dose of charged particles associated with the fourth simulated inspection image, and wherein training the autoencoder based on the first set of codes, the second set of codes, the third set of codes, and the fourth set of codes comprises:
swapping the first code and the second code to generate a first updated set of codes comprising the second code and a second updated set of codes comprising the first code;
setting the third code to be a first random value to generate a third updated set of codes and the fourth code to be a second random value to generate a fourth updated set of codes;
training the autoencoder based on the first updated set of codes, the second updated set of codes, the third updated set of codes, and the fourth updated set of codes.
45. The computer-implemented method of clause 44, wherein training the autoencoder based on the first updated set of codes, the second updated set of codes, the third updated set of codes, and the fourth updated set of codes comprises:
determining a loss function based on the first updated set of codes and the second updated set of codes;
applying a decoder of the autoencoder to the third updated set of codes to generate a first intermediate output image and to the fourth updated set of codes to generate a second intermediate output image;
applying the encoder on the first intermediate output image to generate a fifth set of codes and on the second intermediate output image to generate a sixth set of codes, wherein the fifth set of codes comprises a fifth code representing a third dose of charged particles associated with the first intermediate output image, and the sixth set of codes comprises a sixth code representing a fourth dose of charged particles associated with the second intermediate output image;
updating the loss function based on a determination that a first difference exceeds a first threshold value and a determination that a second difference exceeds a second threshold value, wherein the first difference is between a value of the third code and a value of the fifth code, and the second difference is between a value of the fourth code and a value of the sixth code; and
training the autoencoder using the updated loss function.

The block diagrams in the figures illustrate the architecture, functionality, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

It will be appreciated that the embodiments of the present disclosure are not limited to the exact construction that has been described above and illustrated in the accompanying drawings, and that various modifications and changes may be made without departing from the scope thereof.

1. A system, comprising:
an image inspection apparatus configured to scan a sample and generate an inspection image of an integrated circuit fabricated on the sample; and
a controller including circuitry, configured to:
generate a set of simulated inspection images, wherein each of the set of simulated inspection images comprises no charging artifact; and
generate a set of inspection images by applying a physics-based model to the set of simulated inspection images;
train a machine learning model using the set of inspection images as input, wherein the machine learning model outputs a set of decoupled features of the set of inspection images; and
apply the trained machine learning model on the inspection image to generate an output inspection image, wherein the output inspection image comprises fewer charging artifacts than the inspection image.

2. A system, comprising:
an image inspection apparatus configured to scan a sample and generate an inspection image of an integrated circuit fabricated on the sample; and
a controller including circuitry, configured to:
obtain a set of inspection images, wherein each of the set of inspection images comprises a charging artifact; and
train a machine learning model using the set of inspection images as input, wherein the machine learning model outputs a set of decoupled features of the set of inspection images.

3. The system of claim 2, wherein the set of inspection images are measured inspection images, and wherein the controller includes circuitry further configured to:
obtain the set of inspection images by performing multiple scans on a test sample, wherein each of the multiple scans is configured to use a different acquisition setting, and the acquisition setting comprises at least one of a beam current, a scan direction, or a landing energy of a beam.

4. The system of claim 2, wherein the set of inspection images are simulated inspection images, and wherein the controller includes circuitry further configured to:
generate a set of simulated inspection images, wherein each of the set of simulated inspection images comprises no charging artifact; and
generate the set of inspection images by applying a physics-based model to the set of simulated inspection images.

5. The system of claim 4, wherein the controller includes circuitry further configured to generate the set of simulated inspection images using a Monte-Carlo based technique.

6. The system of claim 2, wherein the set of inspection images are simulated inspection images, and wherein the controller includes circuitry further configured to:
generate a set of simulated inspection images as the set of inspection images, wherein each of the set of simulated inspection images comprises a charging artifact.

7. The system of claim 2, wherein the set of decoupled features comprise at least one of a feature representing a scan direction, a feature representing a pattern, or a feature representing a dose of charged particles.

8. The system of claim 2, wherein the controller includes circuitry further configured to:
apply the trained machine learning model on the inspection image to generate an output inspection image, wherein the output inspection image comprises fewer charging artifacts than the inspection image.

9. The system of claim 8, wherein the output inspection image comprises a pattern having a surrounding edge blooming.

10. The system of claim 8, wherein the machine learning model comprises an autoencoder, the set of decoupled features comprise a set of codes of the autoencoder, and the set of codes comprise at least one of a code representing a scan direction, a code representing a pattern feature, or a code representing a dose of charged particles.

11. The system of claim 10, wherein the controller includes circuitry further configured to:
apply an encoder of the trained autoencoder on the inspection image to generate the set of codes;
set the code representing the dose of charged particles to a value of zero; and
apply a decoder of the trained autoencoder to the set of codes to generate the output inspection image, wherein the set of codes comprise the changed code representing the dose of charged particles.

12. The system of claim 2, wherein the machine learning model comprises an autoencoder, and the set of decoupled features comprise a set of codes of the autoencoder.

13. The system of claim 12, wherein the set of inspection images comprise a first simulated inspection image, a second simulated inspection image, a third simulated inspection image, and a fourth simulated inspection image, wherein the first simulated inspection image and the second simulated inspection image have a same pattern feature and different scan directions, wherein the third simulated inspection image and the fourth simulated inspection image have different pattern features, and wherein the controller includes circuitry further configured to:
in response to obtaining the first simulated inspection image and the second simulated inspection image, apply an encoder of the autoencoder on the first simulated inspection image to generate a first set of codes and on the second simulated inspection image to generate a second set of codes;
in response to obtaining the third simulated inspection image and the fourth simulated inspection image, apply the encoder on the third simulated inspection image to generate a third set of codes and on the fourth simulated inspection image to generate a fourth set of codes; and
train the autoencoder based on the first set of codes, the second set of codes, the third set of codes, and the fourth set of codes.

14. The system of claim 13, wherein the first set of codes comprises a first code representing a first pattern feature of the first simulated inspection image, the second set of codes comprises a second code representing a second pattern feature of the second simulated inspection image, the third set of codes comprises a third code representing a first dose of charged particles associated with the third simulated inspection image, and the fourth set of codes comprises a fourth code representing a second dose of charged particles associated with the fourth simulated inspection image, and wherein the controller includes circuitry further configured to:
swap the first code and the second code to generate a first updated set of codes comprising the second code and a second updated set of codes comprising the first code;
set the third code to be a first random value to generate a third updated set of codes and the fourth code to be a second random value to generate a fourth updated set of codes;
train the autoencoder based on the first updated set of codes, the second updated set of codes, the third updated set of codes, and the fourth updated set of codes.

15. The system of claim 14, wherein the controller includes circuitry further configured to:
determine a loss function based on the first updated set of codes and the second updated set of codes;
apply a decoder of the autoencoder to the third updated set of codes to generate a first intermediate output image and to the fourth updated set of codes to generate a second intermediate output image;
apply the encoder on the first intermediate output image to generate a fifth set of codes and on the second intermediate output image to generate a sixth set of codes, wherein the fifth set of codes comprises a fifth code representing a third dose of charged particles associated with the first intermediate output image, and the sixth set of codes comprises a sixth code representing a fourth dose of charged particles associated with the second intermediate output image;
update the loss function based on a determination that a first difference exceeds a first threshold value and a determination that a second difference exceeds a second threshold value, wherein the first difference is between a value of the third code and a value of the fifth code, and the second difference is between a value of the fourth code and a value of the sixth code; and
train the autoencoder using the updated loss function.

16. A non-transitory computer-readable medium that stores a set of instructions that is executable by at least one processor of an apparatus to cause the apparatus to perform operations comprising:
obtaining a set of inspection images, wherein each of the set of inspection images comprises a charging artifact; and
training a machine learning model using the set of inspection images as input, wherein the machine learning model outputs a set of decoupled features of the set of inspection images.

17. The non-transitory computer-readable medium of claim 16, wherein the set of inspection images are measured inspection images, and wherein obtaining the set of inspection images comprises:
obtaining the set of inspection images by performing multiple scans on a test sample, wherein each of the multiple scans is configured to use a different acquisition setting, and the acquisition setting comprises at least one of a beam current, a scan direction, or a landing energy of a beam.

18. The non-transitory computer-readable medium of claim 16, wherein the set of inspection images are simulated inspection images, and wherein obtaining the set of inspection images comprises:
generating a set of simulated inspection images, wherein each of the set of simulated inspection images comprises no charging artifact; and
generating the set of inspection images by applying a physics-based model to the set of simulated inspection images.

19. The non-transitory computer-readable medium of claim 18, wherein the operations further comprise generating the set of simulated inspection images using a Monte-Carlo based technique.

20. The non-transitory computer-readable medium of claim 16, wherein the set of inspection images are simulated inspection images, and wherein obtaining the set of inspection images comprises:
generating a set of simulated inspection images as the set of inspection images, wherein each of the set of simulated inspection images comprises a charging artifact.
